(19) United States
(12) Patent Application Publication
(10) Pub. No.: US 2017/0192982 A1
(43) Pub. Date: Jul. 6, 2017

(54) Searching Based On Geographical Density Of Entities

(71) Applicant: Quixey, Inc., Mountain View, CA (US)

(72) Inventors: Eric GLOVER, Palo Alto, CA (US); Rajesh SHENOY, Cupertino, CA (US); Zhaohui CHEN, Saratoga, CA (US)

(21) Appl. No.: 15/394,233

(22) Filed: Dec. 29, 2016

Related U.S. Application Data
(60) Provisional application No. 62/272,901, filed on Dec. 30, 2015.

(51) Int. Cl. G06F 17/30

(52) U.S. Cl. CPC G06F 17/3087; G06F 17/30241; G06F 17/3053

(57) ABSTRACT

A method includes receiving a search query from a user device, determining a geographic search location, and determining geographic endpoint locations for search lines. The search lines radiate outwardly from the geographic search location in predetermined directions. The method includes determining geographic boundaries of a search area for the search query by connecting stored ones of the geographic endpoint locations for the search lines. The method includes determining, from the entity records stored in the memory, search results entities that have geographic locations within the geographic boundaries of the search area and satisfy the search query. The method includes obtaining access mechanisms associated with the search results entities. Each access mechanism, when executed by the user device, causes the user device to transition an application to a corresponding specific state. The method includes transmitting, to the user device, the access mechanisms and link data for the search results entities.

### CROSS-REFERENCE TO RELATED APPLICATIONS

This application claims the benefit of U.S. Provisional Application No. 62/272,901, filed on Dec. 30, 2015. The entire disclosure of the application referenced above is incorporated by reference.

### FIELD

This disclosure relates to generating search results based on geographical density of entities.

### BACKGROUND

In recent years, use of computers, smartphones, and other Internet-connected devices has grown exponentially. Correspondingly, the number of available software applications for such devices has also grown. Today, many diverse native and web software applications can be accessed on any number of different devices, including, but not limited to, smartphones, personal computers, automobiles, and televisions. These diverse applications can range from business driven applications, games, educational applications, news applications, shopping applications, messaging applications, media streaming applications, social networking applications, and so much more. Searching for entities in order to present relevant results and relevant advertising presents challenges due to the distribution of entities over a geographical area.

### SUMMARY

A method includes: receiving, by one or more processors, a search query from a user device; determining, by the one or more processors, a geographic search location for the search query; determining, by the one or more processors, geographic endpoint locations for search lines, respectively, the search lines radiating outwardly from the geographic search location in predetermined directions, respectively, where determining the geographic endpoint locations includes, for each search line of the search lines, by the one or more processors: (i) initializing a distance of the search line to a first value; (ii) determining a possible geographic endpoint location for the search line, the possible geographic endpoint location being the distance away from the geographic search location in the predetermined direction corresponding to the search line; (iii) determining, based on the possible geographic endpoint location and geographic boundaries of a plurality of predetermined unit areas, one of the plurality of predetermined unit areas within which the possible endpoint location lies; (iv) determining, from entity records stored in memory, a number of entities having geographic locations that are within the one of the plurality of predetermined unit areas; (v) determining a decrease in the number of entities relative to a previous number of entities having geographic locations within another predetermined area; (vi) determining whether the decrease is greater than a threshold value; and (vii) in response to the decrease being greater than the threshold value, storing as the endpoint location for the search line one of: (a) the possible geographic endpoint location and (b) a previous instance of the possible geographic endpoint location of the one of the search lines; and in response to the decrease not being greater than the threshold value, incrementing the distance by a predetermined increment value and repeating (ii)-(vii). The method further includes: determining, by the one or more processors, geographic boundaries of a search area for the search query by connecting stored ones of the geographic endpoint locations for the search lines, respectively; determining, by the one or more processors, from the entity records stored in the memory, search results entities that: (i) have geographic locations that are within the geographic boundaries of the search area; and (ii) satisfy the search query; obtaining from memory, by the one or more processors, access mechanisms associated with the search results entities, respectively, where each access mechanism of the access mechanisms, when executed by the user device, causes the user device to transition an application to a specific state associated with the access mechanism; and transmitting to the user device, by the one or more processors, the access mechanisms and link data for the search results entities.

In further features the method further includes: determining, by the one or more processors from the entity records stored in memory, a second set of entities, where each entity of the second set of entities both (i) is associated with a location within a predetermined area around the geographic search location and (ii) satisfies the search query; and, in response to a count of entities in the second set of entities being zero, one of: (i) setting the threshold value to a first predetermined value greater than zero; and (ii) increasing the threshold value.

In further features the method further includes: in response to the count of entities in the second set of entities being greater than zero, one of: (i) setting the threshold value to a second predetermined value that is less than the first predetermined value; and (ii) decreasing the threshold value.

In further features the method further includes: receiving from the user device, by the one or more processors, a geographic location of the user device, where determining the geographic search location for the search query includes setting the geographic search location to the geographic location of the user device.

In further features the method further includes: receiving from the user device, by the one or more processors, an Internet Protocol (IP) address of the user device, where determining the geographic search location for the search query includes determining the geographic search location for the search query based on the IP address of the user device.

In further features, determining the geographic search location for the search query includes, by the one or more processors, determining the geographic search location for the search query based on one or more words included in the search query.

In further features the method further includes: receiving from the user device, by the one or more processors, a transportation selection indicative of a type of transportation of a user of the user device; and, by the one or more processors, at least one of: setting the threshold value based on the transportation selection; and setting the predetermined increment value based on the transportation selection.

In further features the method further includes: determining, by the one or more processors from the entity records stored in memory, a second set of entities, where each entity of the second set of entities is associated with a location within a predetermined area centered at the geographic search location, where the previous number of entities having geographic locations within another predetermined area is a count of entities in the second set of entities.

In further features, the previous number of entities having geographic locations within another predetermined area is the number of entities within another predetermined unit area from a previous iteration of (iv) for the search line.

In further features, each access mechanism of the access mechanisms, when executed by the user device, causes the user device to at least one of: transition a software application installed on the user device to the specific state; launch a web browser application installed on the user device and access a specific webpage; and access a digital distribution platform to download an application.

In a feature, a non-transitory computer-readable medium storing instructions for execution by one or more processors of a computing device, the instructions including instructions for: determining a geographic search location for a search query received from a user device; determining geographic endpoint locations for search lines, respectively, the search lines radiating outwardly from the geographic search location in predetermined directions, respectively, where the instructions for determining the geographic endpoint locations include, for each search line of the search lines, instructions for: (i) initializing a distance of the search line to a first value; (ii) determining a possible geographic endpoint location for the search line, the possible geographic endpoint location being the distance away from the geographic search location in the predetermined direction corresponding to the search line; (iii) determining, based on the possible geographic endpoint location and geographic boundaries of a plurality of predetermined unit areas, one of the plurality of predetermined unit areas within which the possible endpoint location lies; (iv) determining, from entity records stored in memory, a number of entities having geographic locations that are within the one of the plurality of predetermined unit areas; (v) determining a decrease in the number of entities relative to a previous number of entities having geographic locations within another predetermined area; (vi) determining whether the decrease is greater than a threshold value; and (vii) in response to the decrease being greater than the threshold value, storing as the endpoint location for the search line one of: (a) the possible geographic endpoint location and (b) a previous instance of the possible geographic endpoint location of the one of the search lines; and in response to the decrease not being greater than the threshold value, incrementing the distance by a predetermined increment value and repeating (ii)-(vii). The instructions further include instructions for: determining geographic boundaries of a search area for the search query by connecting stored ones of the geographic endpoint locations for the search lines, respectively; determining, from the entity records stored in the memory, search results entities that: (i) have geographic locations that are within the geographic boundaries of the search area; and (ii) satisfy the search query; obtaining, from memory, access mechanisms associated with the search results entities, respectively, where each access mechanism of the access mechanisms, when executed by the user device, causes the user device to transition an application to a specific state associated with the access mechanism; and transmitting, to the user device, the access mechanisms and link data for the search results entities.

In further features, the non-transitory computer-readable medium further includes instructions executed by the one or more processors for: determining, from the entity records stored in memory, a second set of entities, where each entity of the second set of entities both (i) is associated with a location within a predetermined area around the geographic search location and (ii) satisfies the search query; and, in response to a count of entities in the second set of entities being zero, one of: (i) setting the threshold value to a first predetermined value greater than zero; and (ii) increasing the threshold value.

In further features, the non-transitory computer-readable medium further includes instructions executed by the one or more processors for, in response to the second count of entities in the second set of entities being greater than zero, one of: (i) setting the threshold value to a second predetermined value that is less than the first predetermined value; and (ii) decreasing the threshold value.

In further features, the instructions for determining the geographic search location for the search query include instructions for setting the geographic search location to a geographic location of the user device received from the user device.

In further features, the instructions for determining the geographic search location for the search query include instructions for determining the geographic search location for the search query based on an Internet Protocol (IP) address of the user device received from the user device.

In further features, the instructions for determining the geographic search location for the search query include instructions for determining the geographic search location for the search query based on one or more words included in the search query.

In further features, the non-transitory computer-readable medium further includes instructions executed by the one or more processors for: at least one of: setting the threshold value based on a transportation selection received from the user device, the transportation selection being indicative of transportation of a user of the user device; and setting the predetermined increment value based on the transportation selection.

In further features, the non-transitory computer-readable medium further includes instructions executed by the one or more processors for determining, by the one or more processors from the entity records stored in memory, a second set of entities, where each entity of the second set of entities is associated with a location within a predetermined area centered at the geographic search location, where the instructions for (v) determining the decrease in the number of entities relative to the previous number of entities having geographic locations within another predetermined area include instructions for (v) determining the decrease in the number of entities relative to a count of entities in the second set of entities.

In further features, the instructions for (v) determining the decrease in the number of entities relative to the previous number of entities having geographic locations within another predetermined area include instructions for (v) determining the decrease in the number of entities relative to the number of entities determined from a previous iteration of (iv) for the search line.

In further features, each access mechanism of the access mechanisms, when executed by the user device, causes the user device to at least one of: transition a software application installed on the user device to the specific state; launch a web browser application installed on the user device and access a specific webpage; and access a digital distribution platform to download an application.

In a feature, a system includes one or more processors and memory including instructions that, when executed by the one or more processors, cause the one or more processors to: determine a geographic search location for a search query received from a user device; determine geographic endpoint locations for search lines, respectively, the search lines radiating outwardly from the geographic search location in predetermined directions, respectively, the determination of the geographic endpoint locations including, for each search line of the search lines: (i) initializing a distance of the search line to a first value; (ii) determining a possible geographic endpoint location for the search line, the possible geographic endpoint location being the distance away from the geographic search location in the predetermined direction corresponding to the search line; (iii) determining, based on the possible geographic endpoint location and geographic boundaries of a plurality of predetermined unit areas, one of the plurality of predetermined unit areas within which the possible endpoint location lies; (iv) determining, from entity records stored in memory, a number of entities having geographic locations that are within the one of the plurality of predetermined unit areas; (v) determining a decrease in the number of entities relative to a previous number of entities having geographic locations within another predetermined area; (vi) determining whether the decrease is greater than a threshold value; and (vii) in response to the decrease being greater than the threshold value, storing as the endpoint location for the search line one of: (a) the possible geographic endpoint location and (b) a previous instance of the possible geographic endpoint location of the one of the search lines; and in response to the decrease not being greater than the threshold value, incrementing the distance by a predetermined increment value and repeating (ii)-(vii). The memory further includes instructions that, when executed by the one or more processors, cause the one or more processors to: determine geographic boundaries of a search area for the search query by connecting stored ones of the geographic endpoint locations for the search lines, respectively; determine, from the entity records stored in the memory, search results entities that: (i) have geographic locations that are within the geographic boundaries of the search area; and (ii) satisfy the search query; obtain from memory access mechanisms associated with the search results entities, respectively, where each access mechanism of the access mechanisms, when executed by the user device, causes the user device to transition an application to a specific state associated with the access mechanism; and transmit to the user device, the access mechanisms and link data for the search results entities.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

FIG. 1A is a schematic view of an example environment including a user device in communication with a search system.

FIG. 1B is a functional block diagram of a search system interacting with an entity system, user devices, and data sources.

FIG. 2 is a schematic view of an example user device.

FIG. 3A is a schematic view of an example user device in communication with a search system.

FIGS. 3B and 3C are schematic views of example function records.

FIG. 4A is a schematic view of an example entity system.

FIG. 4B is a schematic view of an example entity geographical density.

FIG. 4C is a schematic view of an example entity search line including geographical density, initial points and terminal points.

FIG. 4D is a schematic view a search area formed from the terminal points.

FIG. 4E is a schematic view of an example entity geographical search.

FIG. 5A is a schematic view of an example advertising system.

FIG. 5B is a schematic view of an example advertising record.

FIGS. 6A and 6B include a flowchart depicting an example method for performing a location-based search.

FIG. 7 is a schematic view of an example computing device executing any systems or methods described herein.

FIG. 8 includes a flowchart depicting an example method for performing a location-based search.

FIGS. 9A-9H include example illustrations associated with the performance of a location-based search.

Like reference symbols in the various drawings indicate like elements.

### DETAILED DESCRIPTION

A search system of the present disclosure implements a search based on a distribution of density of entities around a user device location. The search system includes an entity system containing entity records including geolocation data. Using a search location, the system determines the geographical density of the entities surrounding the search location by the geolocation data of the entity records. The system draws search lines in different directions radially outwardly from the search location. The search system terminates a search line when a change occurs in the geographical density of the entities along that search line. Each search line therefore includes an initial point at the search location and a terminal point based on where the change in geographical density occurs. The system connects the terminal points of the search lines to determine a search area. Based on a search query, the system searches entity records, function records, and advertising records to determine search results that are relevant to the search query and that are within the search area.

### System Overview

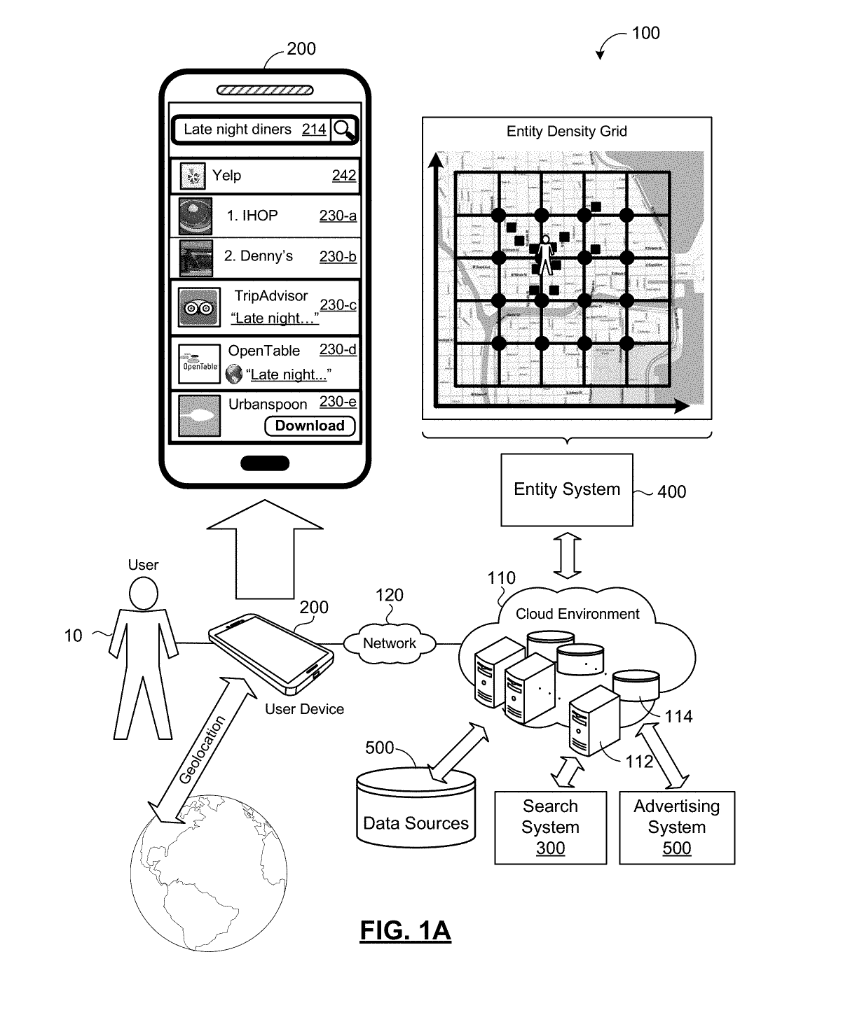

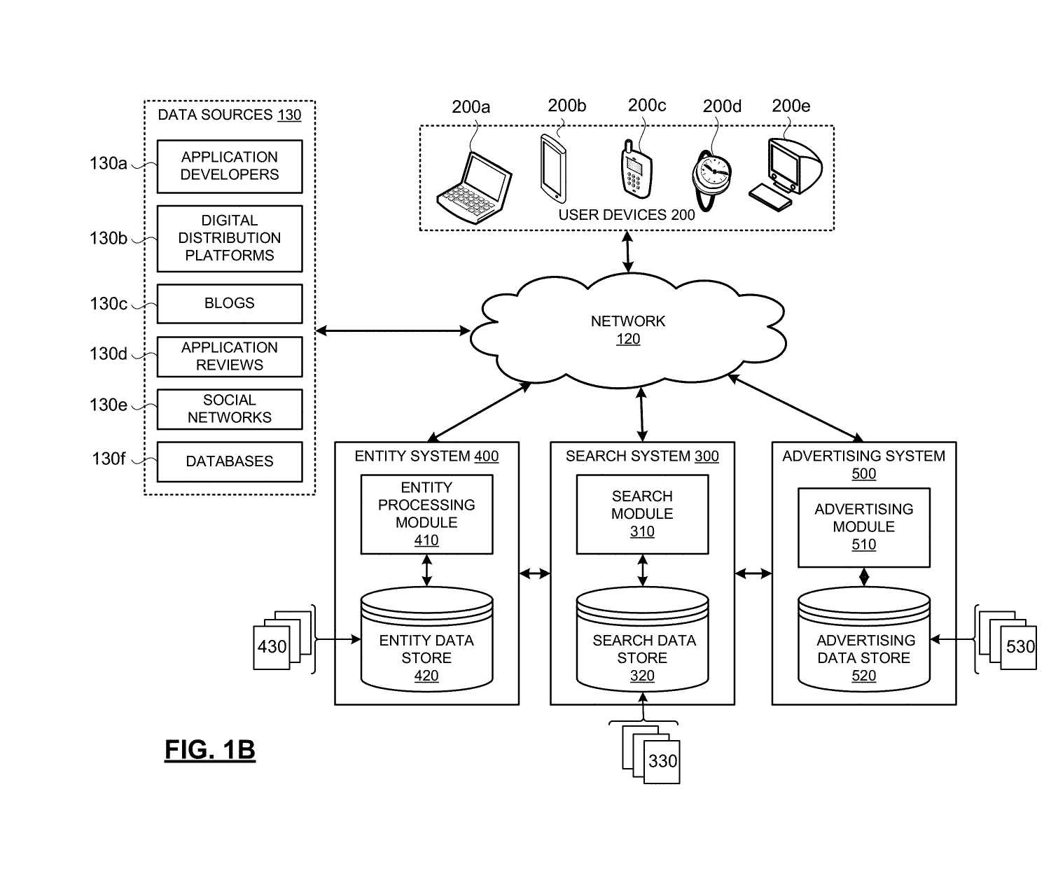

FIG. 1A illustrates an example system 100 that includes a user device 200 associated with a user 10 in communication with a remote system 110 via a network 120. FIG. 1B provides a functional block diagram of the system 100. The remote system 110 may be a distributed system (e.g., cloud environment) having scalable/elastic computing resources (data processing hardware) 112 and/or storage resources 114. The user device 200 and/or the remote system 110 implement a search system 300, an entity system 400, and advertising system 500 and optionally receive data from one or more data sources 130. In some implementations, the search system 300, the entity system 400, and the advertising system 500 communicate with one or more user devices, such as the user device 200, and the data source(s) 130 via the network 120. The network 120 may include various types of networks, such as a local area network (LAN), wide area network (WAN), and/or the Internet.

### User Device

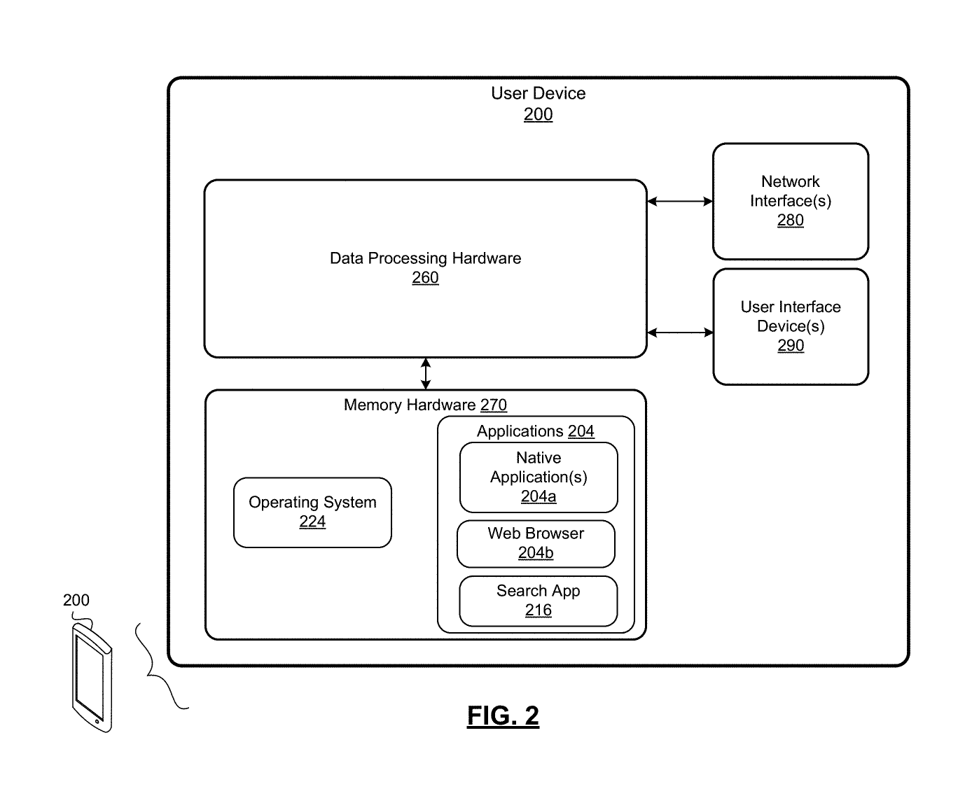

FIG. 2 shows an example of the user device 200. The user device 200 is a computing device configured to provide query wrappers, such as query wrapper 210, to the search system 300. Examples of user devices include, but are not limited to, mobile computing devices, such as laptops 200a, tablets 200b, and smart phones 200c, and wearable computing devices 200d, such as headsets and watches. Other examples of user devices include other computing devices having other form factors, such as computing devices included in desktop computers 200e, vehicles, gaming devices, televisions, or other appliances (e.g., networked home automation devices and home appliances).

The user device 200 may execute one or more software applications 204. A software application may refer to computer software that, when executed by a computing device, causes the computing device to perform a task. In some examples, a software application is referred to as an “application”, an “app”, or a “program”. Examples the software applications 204 include, but are not limited to, word processing applications, spreadsheet applications, messaging applications, media streaming applications, social networking applications, and games. In some examples, ones of the software applications 204 are installed on the user device 200 prior to the user 10 purchasing the user device 200. Additionally or alternatively, ones of the software applications 204 may be downloaded and installed on the user device 200.

The user device 200 may use a variety of different operating systems, such as operating system 224. In examples where the user device 200 is a mobile device, the user device 200 may run an operating system including, but not limited to, ANDROID® developed by Google Inc., IOS® developed by Apple Inc., or WINDOWS PHONE® developed by Microsoft Corporation. Accordingly, the operating system 224 running on the user device 200 may include, but is not limited to, one of ANDROID®, IOS®, or WINDOWS PHONE®. In an example where the user device 200 is a laptop or desktop computing device, the user device 200 may run an operating system including, but not limited to, MICROSOFT WINDOWS® by Microsoft Corporation, MAC OS® by Apple, Inc., or Linux. User devices may also access the search system while running operating systems other than those operating systems described above, whether presently available or developed in the future.

In the example shown, the user device 200 includes data processing hardware 260 in communication with memory hardware 270, one or more network interface devices 280, and one or more user interface devices 290. The user device 200 may also include other components not explicitly depicted. The data processing hardware 260 may include one or more processors. In implementations where the data processing hardware 260 includes two or more processors, the processors can execute in a distributed or individual manner.

The memory hardware 270 (e.g., random access memory (RAM), read-only memory (ROM), hard disk drive, and/or flash memory) stores instructions that, when executed by the data processing hardware 260, cause the data processing hardware 260 to perform one or more operations. The memory hardware 270 may store computer readable instructions that make up one or more native applications 204a, a web browser application 204b, and/or the operating system 224. The operating system 224 acts as an interface between the data processing hardware 260 and the software applications 204.

The network interface devices 280 include one or more devices configured to communicate with the network 120. The network interface devices 280 can include one or more transceivers for performing wired and/or wireless communication. Examples of the network interface devices 280 may include, but are not limited to, a transceiver configured to perform communications using the IEEE 802.11 wireless standard, another type of wireless transceiver, an Ethernet transceiver configured to communicate over an Ethernet cable, and a universal serial bus (USB) transceiver.

The user interface devices 290 include one or more devices configured to receive input from and/or provide output to the user 10. The user interface devices 290 can include, but are not limited to, a touchscreen display 272, a non-touchscreen display, a QWERTY keyboard, another type of keyboard, a numeric keypad, a touchpad, a microphone, one or more speakers, and/or one or more other types of user interface devices.

### Search System

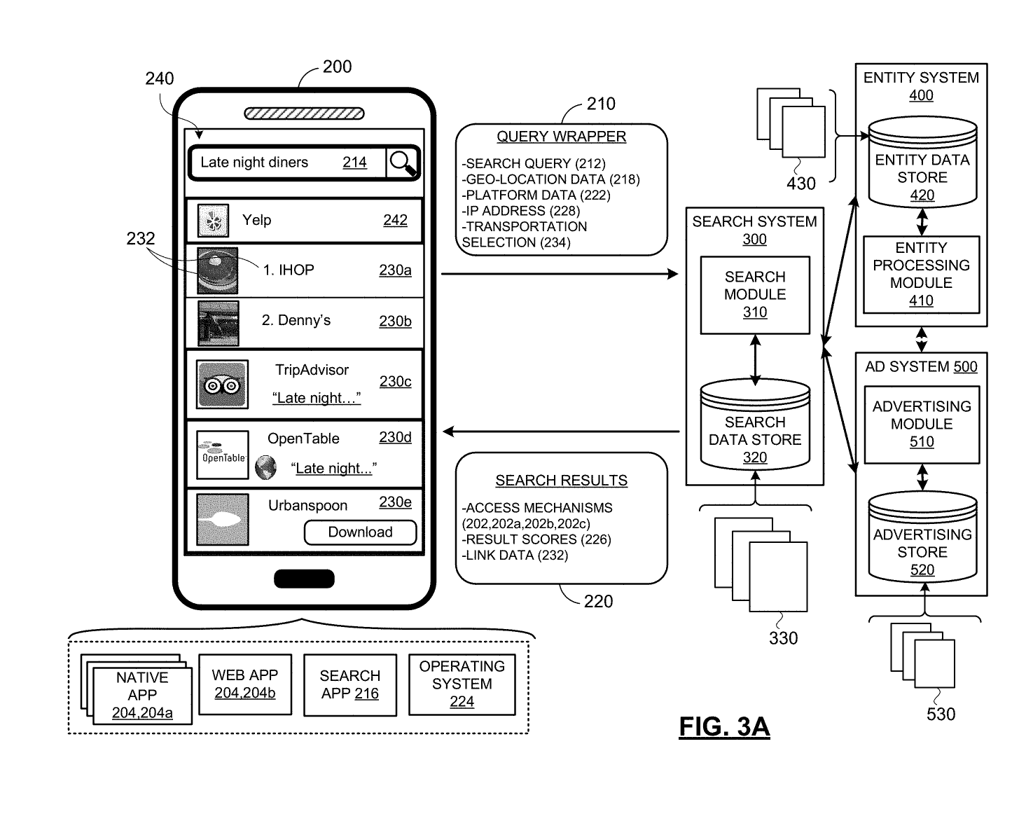

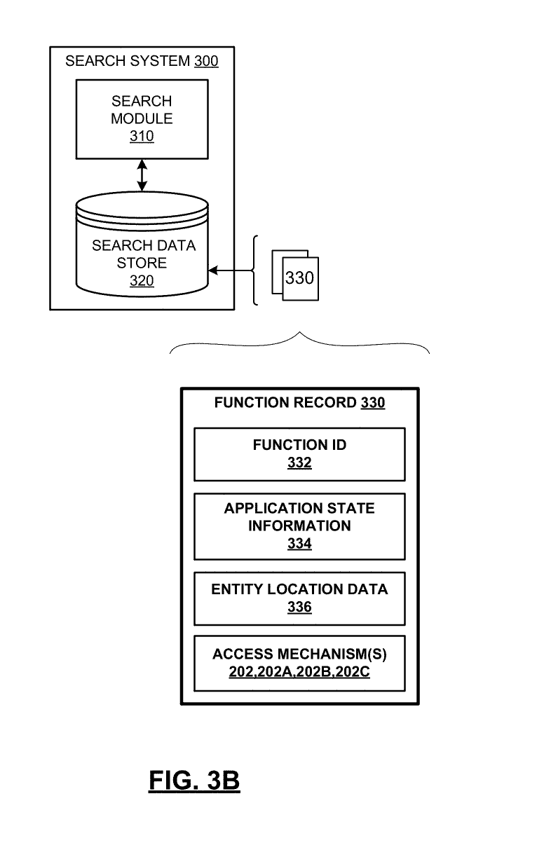

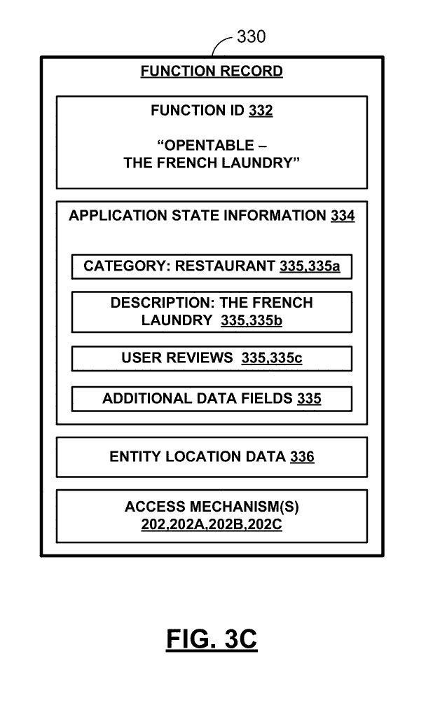

FIG. 3A shows an example of the user device 200 in communication with the search system 300. In general, the user device 200 may communicate with the search system 300 using one or more of the software applications 204 configured to transmit the query wrappers 210 to the search system 300. In some examples, the user device 200 executes one of the native applications 204a that is dedicated to interfacing with the search system 300, such as a search application 216. In some examples, the user device 200 communicates with the search system 300 using a more general one of the software applications 204, such as the web browser application 204b. Although the user device 200 may communicate with the search system 300 using a native application and/or a web-browser application, the user device 200 may be described hereinafter as using the native search application 216 to communicate with the search system 300.

In some implementations, the search system 300 includes a search module 310 in communication with a search data store 320. The search data store 320 may include one or more databases, indices (e.g., inverted indices), tables, files, or other data structures, which may be used to implement the techniques of the present disclosure.

The search module 310 receives query wrappers and generates search results based on the data included in the search data store 320 and the query wrappers, respectively. For example, the search module 310 receives the query wrapper 210 and generates search results 220 based on the data included in the search data store 320 and the query wrapper 210.

In some implementations, the search module 310 receives the query wrappers and performs searches for function records 330 included in the search data store 320 based on data included in the respective query wrappers. For example, the search module 310 receives the query wrapper 210 and performs a search for ones of the function records 330 included in the search data store 320 based on data included in the query wrapper 210, such as a search query 212, and further based on a search area 470 defined by entity system 400.

The function records 330 include one or more access mechanisms 202 that the user device 200 can use to access different functions for a variety of different software applications, such as the native applications 204a installed on the user device 200. The search module 310 transmits the search results 220 including a list of access mechanisms 202 to the user device 200 that generated the query wrapper 210.

The search module 310 receives the query wrappers from user devices via the network 120. Each query wrapper may include various data. For example, the query wrapper 210 may include the search query 212, which may include text, numbers, and/or symbols (e.g., punctuation) entered into the user device 200 by the user 10. For example, the user 10 may enter the search query 212 into a search field 214 (e.g., a search box) of a graphical user interface (GUI) 240 of the search application 216 running/executing on the user device 200. The user 10 may enter the search query 212 using a touchscreen keypad, a mechanical keypad, a speech-to-text program, and/or via one or more other forms of user input.

In general, the search query 212 may be a request for information retrieval (e.g., search results) from the search system 300. For example, the search query 212 may be directed to retrieving a list of user-selectable links 230 to application functionality or application states in examples where the search system 300 generates a list of the access mechanisms 202 as the search results 220. A search query directed to retrieving a list of user-selectable links to application functionality may indicate a user's desire to access functionality of one or more applications described by the search query.

In some examples, the search application 216 is one of the native applications 204a installed on the user device 200 before or after purchase of the user device 200. The search application 216 may receive search queries, such as the search query 212, generate query wrappers, such as the query wrapper 210, and display received data included in the returned search results, such as the search results 220. In additional examples, the user device 200 may execute the web-browser application 204b that accesses a web-based search application. In this example, the user 10 interacts with the web-based search application via the web-browser application 204b installed on the user device 200. In additional examples, the functionality attributed to the search application 216 is included as a searching component of one of the software applications 204 that has additional functionality. For example, the functionality attributed to the search application 216 may be included as part of a native/web-browser application 204a/204b as a feature that provides search for the native/web-browser application 204a/204b.

The query wrapper 210 may include additional data along with the search query 212. For example, the query wrapper 210 may include geolocation data 218 that indicates the location of the user device 200, such as latitude and longitude coordinates of the user device 200 when the query wrapper 210 is generated. The user device 200 may include a global positioning system (GPS) receiver that generates the geolocation data 218 included in the query wrapper 210. The query wrapper 210 may also include an IP address 228, which the search module 310 may use to determine the location of the user device 200. In other words, the search module 310 may determine the location of the user device 200 based on the IP address 228 of the user device 200 included in the query wrapper 210. In some examples, the query wrapper 210 also includes additional data, including, but not limited to, platform data 222 (e.g., a version of the operating system 224, a device type of the user device 200, and a version of the web-browser application 204b), an identity of the user 10 of the user device 200 (e.g., a username), partner specific data, and other data.

The query wrapper 210 may also include a transportation selection 234 related to a mode of transportation that the user 10 is using. The transportation selection 234 may be automatically determined, for example, based on a change between geolocations of the user device 200, or the user 10 may select the transportation selection 234.

The search module 310 generates the search results 220 based on the search query 212 and the additional data included in the query wrapper 210. For example, the search module 310 can determine the geolocation 218 of the user device 200, and the entity system 400 can determine a search area 470 for the query wrapper 210 based on the geolocation 218 of the user device 200. The search module 310 can use the search area 470 along with the search query 212 to generate the search results 220. The search module 310 can determine the geolocation 218 of the user device 200 based on the geolocation data 218 included in the query wrapper 210 or based on other data (e.g., the IP address 228) included in the query wrapper 210.

The search module 310 may set a search location for the search query 212 to the geolocation 218 of the user device 200. In some implementations, the search module 310 may set the search location for the search query 212 to another location (e.g., a postal address, a monument, point of interest, etc.) specified in the search query 212 (i.e., a query-specified location). In these implementations, after the entity system 400 generates a search area 470 based on the detected search location, the search module 310 can use the search area 470 along with the search query 212 to generate the search results 220.

The search module 310 performs a search for function records 330 included in the search data store 320 in response to the received query wrapper 210 (e.g., in response to the search query 212 and the geolocation data 218). In some examples, the search module 310 may use the search area 470 as a filter, e.g., by only searching for function records with entity location data 336 that is within the search area 470.

In other examples, the search module 310 may use the search area 470 to modify scoring for generation of the search results 220. The search module 310 may generate result scores 226 for the function records 330, respectively, identified during the search. The result score associated with a function record may indicate the relevance of that function record to the search query 212. For example, a higher result score may indicate that the associated function record is more relevant to the search query 212. Conversely, a lower result score may indicate that the associated function record is less relevant to the search query 212. Using this example, the search module 310 may increase the result scores of function records having entity location data that is within the search area 470 and/or decrease the result scores of function records having entity location data that is outside of the search area 470. While this example is provided, higher result scores may be used to indicate less relevance while lower result scores may be used to indicative of greater relevance.

The search module 310 may retrieve the access mechanisms 202 from the scored function records 330, respectively. The search module 310 can transmit the result scores along with the access mechanisms retrieved from the scored function records in order to indicate the rank of the access mechanisms among other transmitted access mechanisms 202. For example, the access mechanisms may be ranked in order from highest result score to lowest result score.

The search module 310 may transmit additional data to the user device 200 along with the access mechanisms 202 and the result scores 226. For example, the search module 310 may transmit data (e.g., text and/or images) to be included in the user-selectable links 230. Data for the user-selectable links 230 (e.g., text and/or images) may be referred to as link data, such as link data 232. The user device 200 displays the user-selectable links 230 to the user 10 on the display 272 based on received link data 232. Each of the user-selectable links 230 may be associated with one of the access mechanisms 202 included in the search results 220, such that when the user 10 selects one of the user-selectable links 230, the user device 200 launches the application 204 referenced in the associated one of the access mechanisms 202 and transitions the application 204 to the state specified by that one of the access mechanisms 202.

The user device 200 receives the search results 220 from the search module 310 in response to transmitting the query wrapper 210 to the search system 300. The user device 200 receives search results from the search module 310 in response to each query wrapper transmitted.

The GUI 240 of the search application 216 displays (e.g., renders) the search results 220 received from the search module 310. The search application 216 may display the search results 220 to the user 10 in a variety of different ways depending on what information is transmitted to the user device 200.

The user device 200 generates the user-selectable links 230 (e.g., the user-selectable links 230a, 230b, . . . , 230e) based on the received search results 220. Each of the user-selectable links 230 displayed to the user 10 may include one of the access mechanisms 202. The user 10 may select the user-selectable links 230 on the user device 200 by interacting with the user-selectable links 230, such as by touching or clicking the user-selectable links 230. In response to user input indicative of selection of one of the user-selectable links 230, the user device 200 may launch a corresponding one of the software applications 204 (e.g., one of the native applications 204a or the web-browser application 204b) referenced by the associated one of the access mechanisms 202 and perform one or more operations indicated in the associated one of the access mechanisms 202 to transition the one of the software applications 204 to a specific state.

The user 10 may access the functionality of ones of the applications 204 on the user device 200 on which the applications 204 are installed. Additionally or alternatively, the user 10 may access the functionality of ones of the applications 204 via a remote computing device. In some examples, all of an application's functionality is included on the user device 200 on which the application is installed. Such applications may function without communication with other computing devices (e.g., via the Internet). In additional examples, an application installed on the user device 200 may access information from other remote computing devices during operation. For example, a weather application installed on the user device 200 may access the latest weather information via the Internet and display the accessed weather information to the user 10 on the display 272 through the installed weather application. In further examples, an application (e.g., the web-browser application 204b) may be partially executed by the user device 200 and partially executed by one or more remote computing devices. For example, the web-browser application 204b may be an application that is executed, at least in part, by a web server and accessed by a web browser of the user device 200. Examples of web applications that are executed at least partly by one or more remote computing devices may include, but are not limited to, web-based email, online auctions, and online retail sites.

The access mechanisms 202 may include at least one of a native application access mechanism 202a (hereafter “application access mechanism”), a web access mechanism 202b, and an application download mechanism 202c. The user device 200 may use the access mechanisms 202 to access functionality of applications 204. For example, the user 10 may select one of the user-selectable links 230 including one of the access mechanisms 202 in order to access functionality of one of the software applications 204 indicated in the one of the user-selectable links 230. The search module 310 may transmit one or more of the access mechanisms 202, such as one or more application access mechanisms, one or more web access mechanisms, and/or one or more application download mechanisms, to the user device 200 in the search results 220.

Each application access mechanism, such as the application access mechanism 202a, may be a string that includes a reference to one of the native applications 204a and indicates one or more operations for the user device 200 to perform. When the user 10 selects one of the user-selectable links 230 including an application access mechanism, the user device 200 launches the one of the native applications 204a referenced in the application access mechanism and performs the one or more operations indicated in the application access mechanism to transition the one of the native applications 204a to transition the one of the native applications 204a to a specific state.

Each web access mechanism, such as the web access mechanism 202b, may include a resource identifier that includes a reference to a web resource (e.g., a page of a web application/website). For example, a web access mechanism may include a uniform resource locator (URL) (i.e., a web address) used with hypertext transfer protocol (HTTP). When the user 10 selects one of the user-selectable links 230 including a web access mechanism, the user device 200 may launch the web browser application 204b and retrieve the web resource indicated in the resource identifier of the web access mechanism. Put another way, when the user 10 selects one of the user-selectable links 230 including a web access mechanism, the user device 200 launches the corresponding web-browser application 204b and accesses a specific state (e.g., a webpage) of a web application or website. In some examples, web access mechanisms include URLs for mobile-optimized sites and/or full sites.

Each application download mechanism, such as the application download mechanism 202c, may indicate a location (e.g., the digital distribution platform 130b) where an associated one of the native applications 204a can be downloaded in the scenario where that native application is not presently installed on the user device 200. When the user 10 selects one of the user-selectable links 230 including an application download mechanism, the user device 200 accesses a digital distribution platform from which the associated native application may be downloaded. The user device 200 may access the digital distribution platform 130b using at least one of the web-browser application 204b and one of the native applications 204a.

In examples where the search results 220 include a list of the access mechanisms 202 and the link data 232, the search application 216 displays the search results 220 to the user 10 as a list of the user-selectable links 230, which may include text and/or images. The text and/or images in the user-selectable links 230 may include application names associated with the access mechanisms 202, text describing the access mechanisms 202, images associated with the software applications 204 referenced by the access mechanisms 202 (e.g., application icons), and/or images associated with the application state (e.g., application screen images) defined or accessed by the access mechanisms 202, respectively.

In some implementations, the search application 216 displays the search results 220 as a list of the user-selectable links 230 arranged under the search field 214 in which the user 10 entered the search query 212. Moreover, the search application 216 may arrange the user-selectable links 230 in order based on the result scores 226 associated with the access mechanisms 202 included in the user-selectable links 230. In some examples, the search application 216 groups ones of the user-selectable links 230 that are related to the same one of the applications 204 together.

Each of the user-selectable links 230 includes the link data 232. For example, each of the user-selectable links 230 includes an image (e.g., an icon) and text (e.g., an application or business name) that may describe an application and a state of the application. Each of the user-selectable links 230 may include one of the access mechanisms 202 so that, if the user 10 selects one of user-selectable links 230, the user device 200 launches the associated application and transitions the application into a state that is specified by the one of the access mechanisms 202 associated with the selected one of the user-selectable links 230. In some implementations, the user device 200 arranges the user-selectable links 230 based on result scores associated with the access mechanisms 202 included in the user-selectable links 230, such as according to descending order of result scores. In some implementations, such as illustrated in FIG. 3A, the user-selectable links 230 for the same one of the software applications 204 are combined together in the search results 220 displayed to the user 10.

With respect to FIG. 3A, it may be assumed that the YELP® native application developed by Yelp, Inc., and the TRIPADVISOR® native application developed by TripAdvisor, Inc., are installed on the user device 200. The user-selectable links 230a and 230b, reference the YELP® native application, and the user-selectable link 230c references the TRIPADVISOR® native application. The GUI 240 includes a header 242, including the name “Yelp,” under which the first and second links 230a, 230b are arranged. The header 242 may visually indicate that the user-selectable links 230a and 230b arranged below the header 242 are associated with the YELP® native application. In this example, selection of the user-selectable link 230a causes the user device 200 to launch the YELP® native application and retrieve an IHOP® restaurant entry of the YELP® native application. Selection of the user-selectable link 230b causes the user device 200 to launch the YELP® native application and retrieve a DENNY'S® restaurant entry of the YELP® native application. Selection of user-selectable link 230c causes the user device 200 to launch the TRIPADVISOR® native application and retrieve an entry for “Late night diners” in the TRIPADVISOR® native application (e.g., a search for “Late night diners”).

The user-selectable link 230d includes a web access mechanism (e.g., a URL). Selection of the user-selectable link 230d causes the user device 200 to launch the web-browser application 204b and retrieve an entry for “Late night diners” in the OPENTABLE® web-browser application developed by OpenTable, Inc. The user-selectable link 230e includes an application download mechanism for downloading the URBANSPOON® native application by InterActiveCorp. Selection of the user-selectable link 230e causes the user device 200 to access the digital distribution platform 130b (FIG. 1B) from which the URBANSPOON® native application can be downloaded and/or previewed. The search module 310 can be configured to transmit any combination of application access mechanisms, web access mechanisms, and application download mechanisms in the search results 220.

In some examples, the user device 200 communicates with the search system 300 via a partner computing system (not illustrated). The partner computing system may be a computing system of a third party that may leverage the search functionality of the search system 300. The partner computing system may belong to a company or organization other than that which operates the search system 300. Example third parties which may leverage the functionality of the search system 300 may include, but are not limited to, internet search providers and wireless communications service providers. The user device 200 may send the search queries to the search system 300 and receive the search results via the partner computing system. The partner computing system provides a user interface to the user devices 200, in some examples and/or modifies the search experience provided on the user devices 200.

Referring to FIGS. 3B and 3C, the search data store 320 includes the plurality of the function records 330. Each of the function records 330 includes data related to a function of one of the software applications 204 and/or the state of the one of the software applications 204 resulting from performance of the function. For example, a function record may include a function identifier (ID) 332, entity location data 336, application state information 334, and one or more the access mechanisms 202 used to access functionality provided by the one of the software applications 204.

The function ID 332 of one of the function records 330 may be used to identify the function record 330 among the other ones of the function records 330 included in the search data store 320. The function ID 332 may be a string of alphabetic, numeric, and/or symbolic characters (e.g., punctuation marks) that uniquely identifies that one of the function records 330. In some examples, the function ID 332 describes a function and/or an application state in human readable form. For example, the function ID 332 may include the name of the one of the applications referenced in the access mechanism(s) 202. Additionally or alternatively, the function ID 332 may be a human readable string that describes a function performed according to the access mechanism(s) 202 and/or an application state resulting from performance of the function according to the access mechanism(s) 202. In some examples, the function ID 332 includes a string in the format of a uniform resource locator (URL) of a web access mechanism for the one of the function records 330, which may uniquely identify the one of the function records 330.

The application state information 334 of one of the function records 330 may include data that describes an application state into which the one of the applications 204 is set according to the access mechanism(s) 202 in the function record 330. Additionally or alternatively, the application state information 334 may include data that describes the function performed according to the access mechanism(s) 202 included in that one of the function record 330. The application state information 334 may include a variety of different types of data, such as structured, semi-structured, and/or unstructured data. The application state information 334 may be automatically and/or manually generated based on documents retrieved from the data sources 130. Moreover, the application state information 334 may be updated so that up-to-date search results 220 can be provided in response to search queries.

Referring also to FIG. 1B, the data sources 130 may be sources of data that the search system 300 (e.g., the search module 310) may use to generate and update the search data store 320. The data retrieved from the data sources 130 can include any type of data related to application functionality and/or application states. The search system 300 may create or update ones of the function records 330 based on data retrieved from the data sources 130. In some examples, some data included in the data sources 130 may be manually generated by a human operator. Moreover, data included in the function records 330 may be updated over time so that the search system 300 provides up-to-date search results.

The data sources 130 may include a variety of different data providers. The data sources 130 may include data from application developers 130a, such as application developers' websites and data feeds provided by application developers. The data sources 130 may include operators of digital distribution platforms, such as the digital distribution platform 130b configured to distribute native applications to user devices. Examples of the digital distribution platform 130b include, but are not limited to, the GOOGLE PLAY® digital distribution platform by Google, Inc., the APP STORE® digital distribution platform by Apple, Inc., and WINDOWS PHONE® Store developed by Microsoft Corporation.

The data sources 130 may also include other websites, such as websites that include web logs 130c (i.e., blogs), application review websites 130d, or other websites including data related to applications. Additionally, the data sources 130 may include social networking sites 130e, such as “FACEBOOK®” by Facebook, Inc. (e.g., Facebook posts) and “TWITTER®” by Twitter Inc. (e.g., text from tweets). The data sources 130 may also include online databases 130f that include, but are not limited to, data related to movies, television programs, music, and restaurants. The data sources 130 may also include additional types of data sources in addition to the data sources described above. Different ones of the data sources 130 may have their own content and update rate.

Referring again to FIGS. 3B and 3C, in some examples, the application state information 334 includes data that may be presented to the user 10 by the associated one of the applications 204 when the one of the applications 204 is set in the application state defined by the access mechanism(s) 202. For example, if one of the access mechanism(s) 202 is an application access mechanism, the application state information 334 may include data that describes a state of the associated one of the native applications 204a after the user device 200 has performed the one or more operations indicated in the application access mechanism. For example, if the one of the function records 330 is associated with a shopping application, the application state information 334 may include data that describes products (e.g., names and prices) that are shown when the shopping application is set to the application state defined by the access mechanism(s) 202. As another example, if the one of the function records 330 is associated with a music player application, the application state information 334 may include data that describes a song (e.g., name and artist) that is played when the music player application is set to the application state defined by the access mechanism(s) 202. The types of data included in the application state information 334 may depend on the type of information associated with the application state and the functionality defined by the access mechanism(s) 202.

The entity location data 336 of one of the function records 330 may define a geolocation associated with the one of the function records 330. For example, the geolocation defined by the entity location data 336 may be a geolocation or some other data indicative of a location of a place described in the application state information 334. For example, if the access mechanism(s) 202 provides access to reviews of a specific restaurant in Mountain View, Calif., then the entity location data 336 may define a geolocation (e.g., latitude and longitude coordinates) of the specific restaurant, a street address of the restaurant, a visual description of the location (e.g., a human recognizable description based on landmarks and relative distances), or some other location description.

FIG. 3C shows an example one of the function records 330 associated with the OPENTABLE® application, developed by OpenTable, Inc. The OPENTABLE® application is a restaurant-reservation application that allows users to search for restaurants and make restaurant reservations. The OPENTABLE® application provides information about restaurants including descriptions of restaurants and user reviews of the restaurants. The example one of the function records 330 of FIG. 3B describes an application state of the OPENTABLE® application in which the OPENTABLE® application accesses information for THE FRENCH LAUNDRY® restaurant.

The example one of the function records 330 includes the function ID 332 of “OPENTABLE—THE FRENCH LAUNDRY,” which may be used as a unique identifier to identify the example one of the function records 330. In other examples, the function ID 332 could include a URL as a unique identifier for the example one of the function records 330. For example, the function ID 332 may include the string “http://www.opentable.com/the-french-laundry” as a unique identifier for the example one of the function records 330. As described herein, the example function ID 332 may be included in a web access mechanism of the example one of the function records 330. As another example, the function ID 332 may have a different namespace than “http://,” such as “func://.” In yet another example, the function ID 332 could be a string of characters, numbers, and/or symbols that are not in human readable form. Each example is optional and may be combined with other examples.

The example application state information 334 of the example one of the function records 330 includes data fields 335, such as a category 335a of THE FRENCH LAUNDRY® restaurant, a description 335b of THE FRENCH LAUNDRY® restaurant, user reviews 335c of THE FRENCH LAUNDRY® restaurant, and additional data fields 335. The restaurant category 335a field may include the text “French cuisine” and “contemporary,” for example. The description field 335b may include text that describes THE FRENCH LAUNDRY® restaurant. The user reviews field 335c may include text of user reviews for THE FRENCH LAUNDRY® restaurant. The additional data fields 335 may include additional data for THE FRENCH LAUNDRY® restaurant that may not specifically fit within the other defined fields, such as a menu for the restaurant, prices, and operating hours for the restaurant.

The example one of the function records 330 also includes one or more access mechanism(s) 202. The access mechanism(s) 202 may include a reference to the OPENTABLE® application. An example application access mechanism for the example one of the function records 330 may include a reference to the OPENTABLE® native application along with one or more operations to be performed by the user device 200. For example, the application access mechanism may include an application resource identifier and/or one or more operations that cause the user device 200 to access the entry for THE FRENCH LAUNDRY® restaurant in the OPENTABLE® native application. An example application resource identifier may be “vnd.opentable.deeplink://opentable.com/restaurant/profile?rid=1180&refid=1.” The example one of the function records 330 includes the entity location data 336 that includes the geolocation (e.g., latitude and longitude) of THE FRENCH LAUNDRY® restaurant. While only the example one of the function records 330 is shown, the other ones of the function records 330 may include one, more than one, or all of the above types of data.

### Entity System

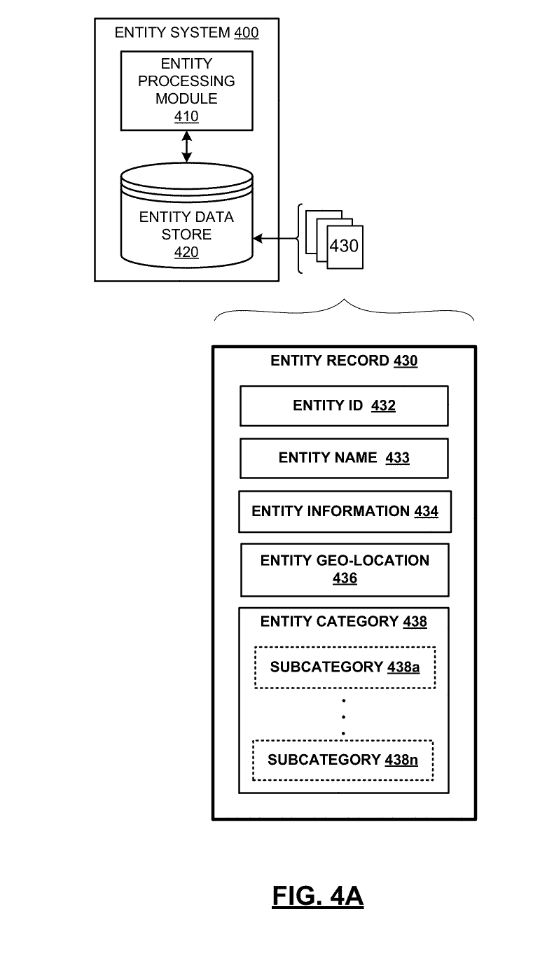

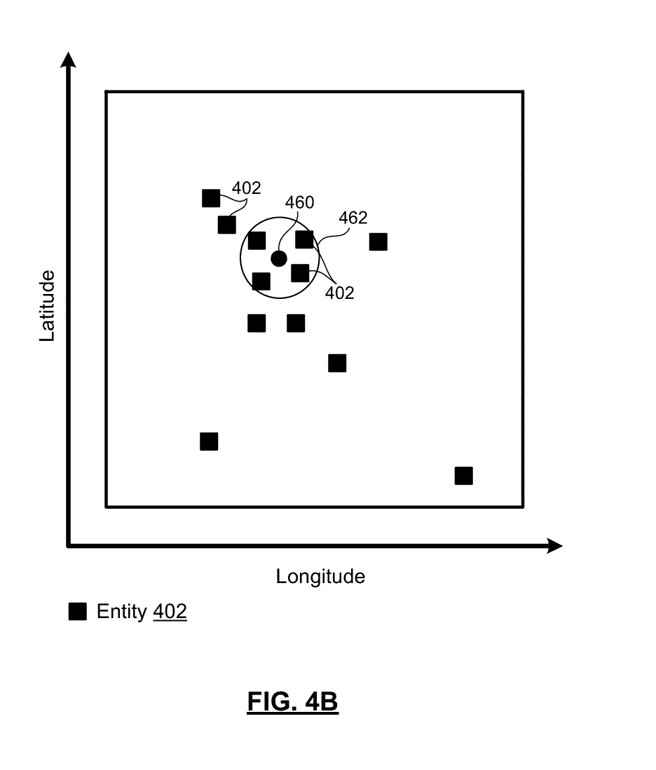

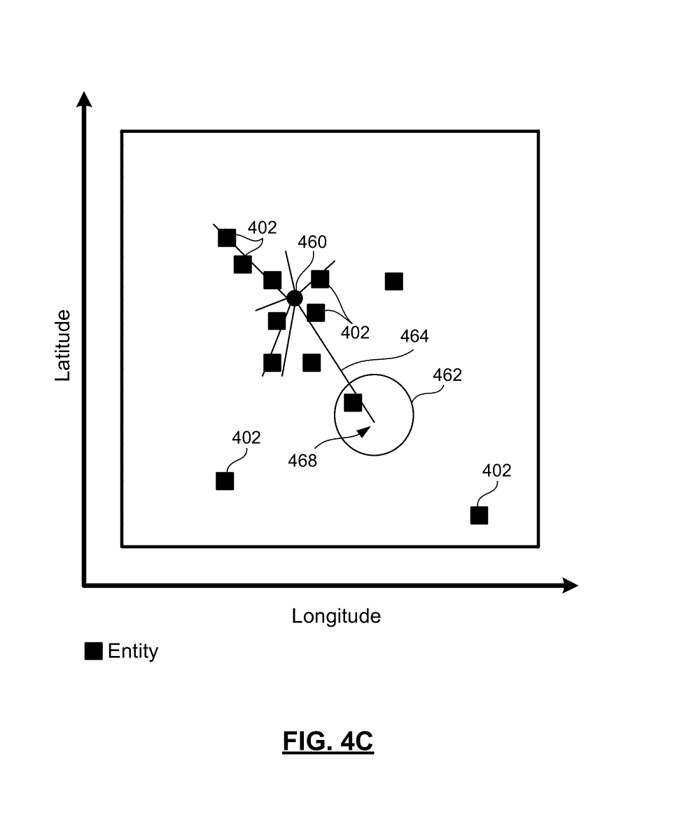

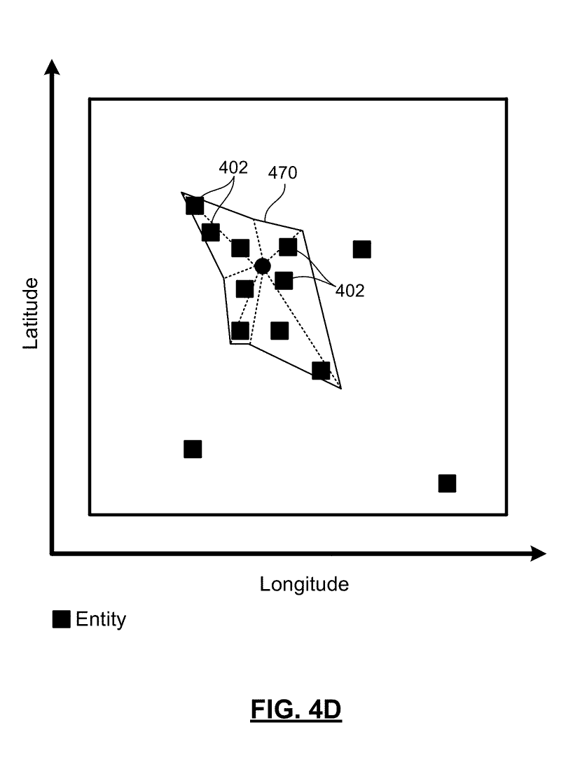

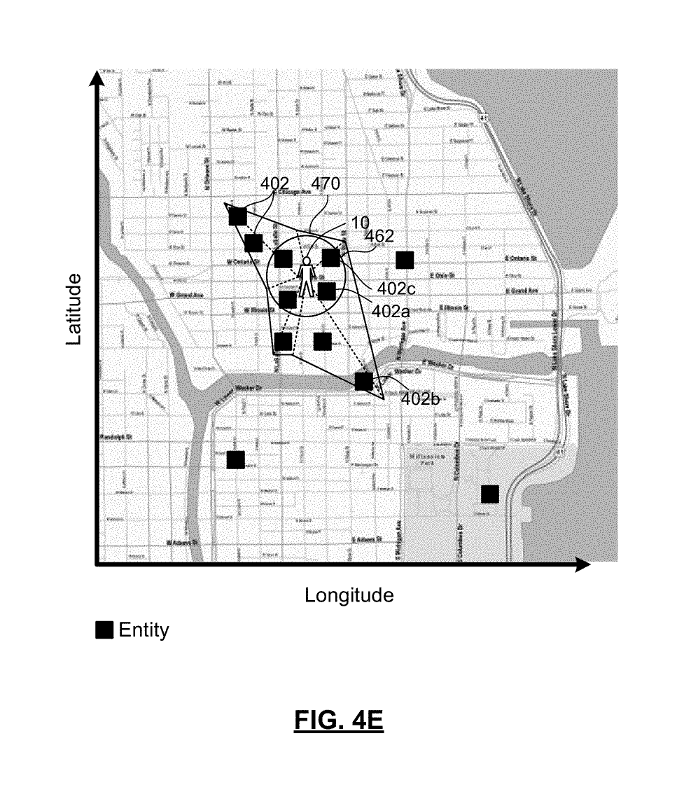

Referring to FIG. 4A, the entity system 400 includes an entity processing module 410 in communication with an entity data store 420, which includes a plurality of entity records 430. Each of the entity records 430 includes data related to a respective entity, such as entity 402 (FIG. 4B). The entity 402 of a given one of the entity records 430 can be any business or place with a geolocation (e.g., restaurants, bars, gas stations, supermarkets, movie theaters, doctor offices, parks, and libraries, etc.). The entity records 430 may each include an entity identifier (ID) 432, an entity name 433, entity location data 336 (e.g., geolocation data), an entity category 438 (and optionally one or more sub-categories 438a-438n), and entity information 434.

The entity ID 432 of one of the entity records 430 may be used to identify the one of the entity records 430 among the other ones of the entity records 430 included in the entity data store 420. The entity ID 432 may be a string of alphabetic, numeric, and/or symbolic characters (e.g., punctuation marks) that uniquely identifies the associated entity record 430. In some examples, the entity ID 432 describes the entity 402 in human readable form. For example, the entity ID 432 may include the name string of the entity 402 or a human readable identifying the entity 402. In some examples, the entity ID 432 includes a string in the format of a uniform resource locator (URL).

In a more specific example, if the one of the entity records 430 describes a restaurant named QDOBA® (Qdoba is a registered trademark of Qdoba Restaurant Corporation), both the entity ID 432 and the entity name 433 for the one of the entity records 430 can be “Qdoba.” In an example where the entity ID 432 includes a string in human readable form and/or a URL, the entity ID 432 may include the following string “Qdoba, 42967 Woodward Avenue, Bloomfield Township, MI 48304” to uniquely identify the one of the entity records 430. Other unique identifiers are possible as well, such as a store number.

The entity information 434 of one of the entity records 430 includes any information about the entity 402 of the one of the entity records 430, such as text (e.g., description, reviews) and numbers (e.g., number of reviews). This information may even be redundant to other information contained in the one of the entity records 430, but optionally structured for display, for example. The entity information 434 may include a variety of different types of data, such as structured, semi-structured, and/or unstructured data. Moreover, the entity information 434 may be automatically and/or manually generated based on documents retrieved from the data sources 130.

The entity location data 436 of one of the entity records 430 includes data that describes a location of the entity 402 of the one of the entity records 430. This data may include a geolocation (e.g., latitude and longitude coordinates), a street address, or any information that can be used to identify the location of the entity 402 within a geographical area. In some implementations, the entity location data 436 defines a geolocation associated with the one of the entity records 430.

The entity category 438 of one of the entity records 430 provides a classification or grouping of the entity 402 of the one of the entity records 430. Moreover, the entity category 438 can have one or more sub-categories to further classify the entity 402. For example, the entity record 430 could have an entity category of “restaurant” and a sub-category a type of cuisine, such as “French cuisine” or “contemporary.” Any number of sub-categories 438a-438n may be assigned to classify the entities of the entity records 430 for use during a search.

Referring to FIGS. 4B-4E, the entity processing module 410 determines a local density 462 of the entities 402 at different geographical locations. In some implementations, for a given one of the entity categories 438, such as a restaurant, the entity processing module 410 determines the local density 462 of the entities 402 of that one of the categories 438 (e.g., restaurants) about a search geolocation. Having a lot of the entities 402 in a particular place or a few the entities 402 in a particular place may affect how the search system 300 conducts its search or generates the search results for a particular query wrapper. For example, if the user 10 is in New York City, the user 10 may likely want search results that are closer in geographic proximity to the user 10, than if the user 10 is in Montana, where the entities 402 are generally more dispersed about a large geographical area. In some cases, the entity processing module 410 may determine the local density 462 of all entities 402 (e.g., without any regard to entity category).

### Entity Geo-Density

Referring to FIGS. 3A and 4B, the user device 200 sends the entity system 400 and/or search system 300 the query wrapper 210 including the search query 212 and the geolocation data 218. The search system 300 and/or entity system 400 determine a search location 460, for example, using the geolocation data 218 contained in the query wrapper 210. In some examples, the search location 460 is the same as the physical location of the user device 200. In other examples, the search location 460 may be specified by the user 10 or detected from the search query 212. For example, if the user device 200 sends the search query 212, “restaurants near the Golden Gate Bridge”, the search system 300 and the entity system 400 may determine from the search query 212 that the search location 460 is the location of the Golden Gate Bridge (e.g., geo-coordinates for the bridge). The entity system 400 determines the local density 462 for the search location 460 by finding ones of the entities 402 that fall within a predetermined area around of the search location 460. In one example, the predetermined area is defined by a radius associated with a fixed measurement unit, including but not limited to, a radius of one or more blocks, a radius of a fraction of a mile, a radius of a mile, etc. In another example, the predetermined area is a predetermined area centered at the search location 460, such as one or more acres, one or more square miles, etc. The entity system 400 finds ones of the entity records 430 with entity geolocations falling within the predetermined area and totals (counts) them to calculate the local density 462 for the search location 460. In some examples, the local density 462 may be the total number of the ones of the entity records 430 with entity geolocations within the predetermined area. In other examples, the local density 462 may be the total number divided by the predetermined area.

Referring to FIG. 4C, the entity system 400 generates numerous search lines 464 relative to the search location 460. For example, the entity system 400 may generate the search lines 464 radially outwardly from the search location 460. Each of the search lines 464 begins at the search location 460 and ends at a respective terminal point 468 where the local density of entities along that search line changes by a threshold change. The entity system 400 generates one of the search lines 464 by incrementally extending the one of the search lines 464 outwards at a certain angle from the search location 460 while checking the local density of entities at successive endpoints of the one of the search lines 464 to find the terminal point 468 of the one of the search lines 464.

Increments may be selected based on the local density 462 within the predetermined area around the search location 460. For example, if search location 460 is in a dense area, the one of the search lines 464 may be extended by increments of a few city blocks to check the local density of each successive endpoint. In contrast, if the search location 460 is in a sparse area (e.g., a rural area), the one of the search lines 464 may be extended by increments of several miles at a time. When the local density 462 of an endpoint does not change by a threshold change, the one of the search lines 464 may be extended by another increment, and the new endpoint checked in a repeating iterative process. This is performed for each of the search lines 464.

The entity system 400 may calculate a change in local density by comparing a local density of the endpoint of one of the search lines 464 to any of the previously calculated local densities for the one of the search lines 464 or for the search location 460. In one example, the entity system 400 may compare the local density for the current endpoint to the local density for the search location 460 to determine the change in local density. In another example, the entity system 400 compares the local density for the current endpoint to the local density for a previous endpoint of the one of the search lines 464 (e.g., the last endpoint before the one of the search lines 464 was most recently incrementally extended). In another example, the entity system 400 compares the local density for the current endpoint to the largest value of local density among all previous points on the one of the search lines 464. In any of the examples, when the change exceeds a threshold, the endpoint (or in some cases, the previous endpoint) may be set as the terminal point 468 for that one of the search lines 464.

The entity system 400 may further determine minimum and/or maximum lengths of the search lines 464. The minimum and/or maximum lengths may be determined based on the local density 462 of the search location 460, the transportation selection 234, or a combination of the two. The entity system 400 may receive the transportation selection 234 indicating the user's mode of transportation from the query wrapper 210 submitted by the user device 200. For example, when the transportation selection 234 indicates “walking,” the entity system 400 may set the maximum length of the search line may to a first predetermined distance, such as a mile or another suitable distance. When the transportation selection 234 indicates “biking,” the entity system 400 may set the maximum length of the search line to a second predetermined distance, such as two or more miles or another suitable distance that is greater than the first predetermined distance for “walking.” When the transportation selection 234 indicates “driving,” the entity system 400 may set the maximum length of the search line to a third predetermined distance, such as four or more miles or another suitable distance that is greater than the second predetermined distance for “biking.” Furthermore, the entity system 400 may set the maximum and minimum lengths to lower distances when the local density around the search location 460 is higher.

The entity system 400 generates the search lines 464 surrounding the search location 460. There is no limit to the number of the search lines 464 the entity system 400 may employ. Moreover, increasing the number of the search lines 464 increases the smoothness of a search area 470, but may not necessarily yield more accurate search results. In some embodiments, the entity system 400 generates a number of evenly (angularly) spaced search lines extending radially outwardly from the search location 460.

Referring to FIG. 4D, the entity system 400 determines the search area 470 by connecting the terminal points 468 of the adjacent ones of the search lines 464. The search area 470 may be used to filter or modify the search results of the search system 300. In an example, the search system 300 only considers ones of the function records 330 having entity location data that falls within the search area 470 (i.e., a hard filter). In other examples, the search system 300 adjusts scoring (e.g., gives a scoring boost) for ones of the function records 330 having entity location data that falls within the search area 470 and does not boost the result scores of ones of the function records 330 having entity location data falling outside of the search area 470.

The search system 300 and/or the entity system 400 may determine the entity category 438 and/or the subcategory based on the search query 212 received from the user device 200. The entity category 438 and/or the subcategory may be used to restrict the set of the entities 402 for generating the search area 470 (e.g., to those ones of the entities 402 matching the entity category 438 and/or the subcategory). In some embodiments, the search system 300 finds search results before the entity system 400 calculates the search area 470. In that case, the search system 300 may detect one or more categories 335 of the function records 330 and indicate to the entity system 400 the category 438 and/or subcategory of entities that should be selected in order to generate the search area 470. In another embodiment, the search system 300 and/or the entity system 400 may extract keywords from a query and determine the category 438 and/or the subcategory based on the keywords. If the category 438 cannot be determined, the entity system 400 may determine the search area 470 without consideration of the category 438 (e.g., considering all of the entities 402 without restricting by category).

In some implementations, the entity system 400 determines whether at least one of the entities 402 located within the search area 470 satisfies the search criteria or the search query 212. When none of the entities 402 located within the search area 470 satisfies the search criteria or the search query 212, the entity system 400 may increase the threshold change in the local density of the entities, causing the search lines 464 to extend to corresponding terminal points located further away from the search location 460 and to increase the search area 470. In some implementations, the location data or the geolocation data 218 is indicative of the physical location of the user device 200 originating the search criteria or the search query 212. The threshold change in the local density of the entities 402 about the search location 460 may be determined by the entity system 400 based on a rate of change of the local density of the entities 402 in relation to the local density of the search location 460.

The entity system 400 may determine whether a count of the identified one or more of the entities 402 exceeds a threshold number. When the count exceeds the threshold number, the entity system 400 may decrease the threshold change in the local density of the entities 402, causing the search lines 464 to extend to corresponding terminal points located closer to the search location 460 and to decrease the search area 470.

In some examples, the entity system 400 obtains the transportation selection 234 indicating a type of transportation, where at least one terminal point identified is based on the transportation selection 234. For example, an increment may be chosen based on the transportation selection 234. Furthermore, as previously discussed, the maximum and minimum lengths of search lines 464 may be adjusted for different transportation selections.

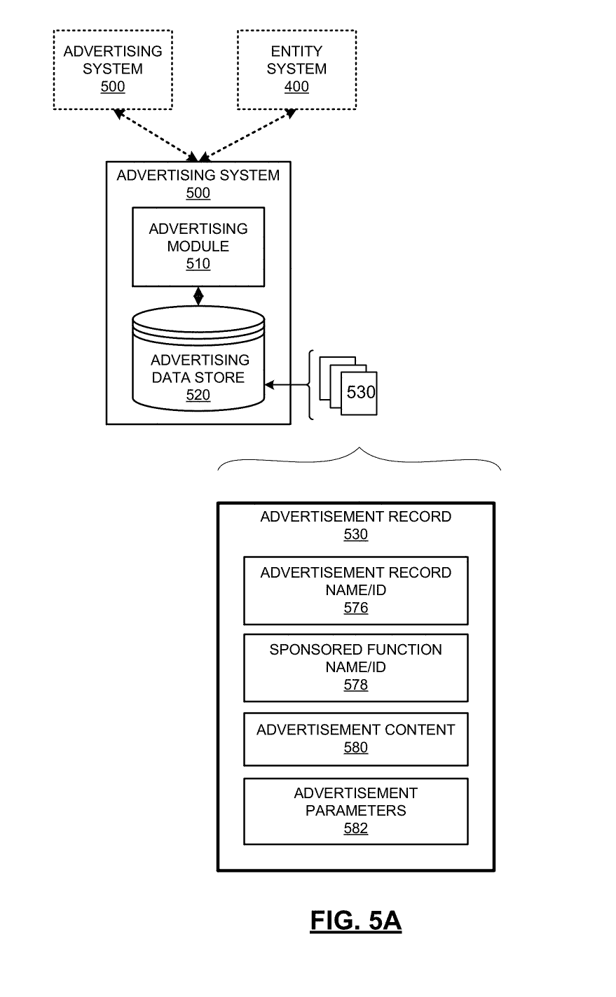

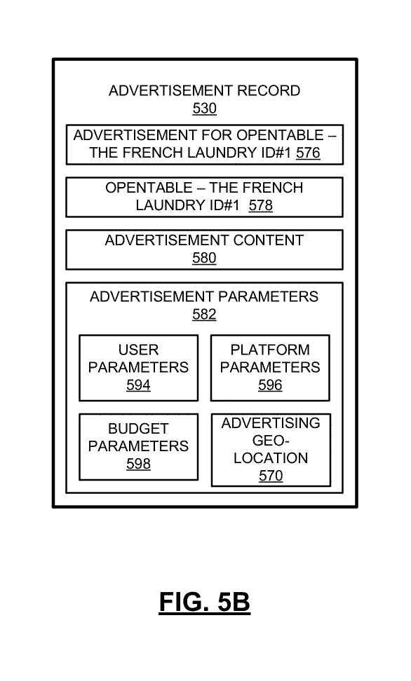

Referring to FIGS. 3A and 4E, the user 10 may be located on a street in Chicago near Kenzie St and LaSalle Blvd. The user 10 requests a search via the user device 200 for “Thai Food”. The user device 200 sends the query wrapper 210, including the search query 212 for “Thai Food,” the geolocation data 218 of the user device 200, the platform data 222, and the IP address 228 to the search system 300, the entity system 400, and the advertising system 500. The entity system 400 may set the search location 460 to the geolocation data 218 provided in the query wrapper 210. In this example (FIG. 4E), the entity system 400 determines the local density 462 of the entities 402 about the search location 460 to be four entities. The entity system 400 determines the search lines 464 based on the local density 462 of the entities 402 about the search location 460, determines the search area 470 by connecting the terminal points 468 of the search lines 464, and, in some embodiments, sends an indication of the entities 402 to the advertising system 500. The advertising system 500 adds a relevant first result entity 402a to the search consideration by reading the advertising records 530 related to the search query 212 and an advertising geolocation 570 (FIG. 5B) that is within the search area 470, as discussed further below. The advertising system 500 nominates the first result entity 402a for inclusion in the search results 220. The entity system 400 sends the entities 402 to the search system 300. The search system 300 determines that a second result entity 402b and a third result entity 402c are relevant to the search query 212 “Thai Food”. The search system 300 sends the search results 220 referencing the first result entity 402a, the second result entity 402b, and the third result entity 402c to the user device 200 as the search results 220. In some examples, the user device 200 displays one of the user-selectable links 230 for the first result entity 402a provided by the advertisement system 500 separately from the user-selectable links 230 for the second result entity 402b and the third result entity 402c. In other examples, the user device 200 displays the one of the user-selectable links 230 for the first result entity 402a provided by the advertisement system 500 intermixed with the user-selectable links 230 for the second result entity 402b and the third result entity 402c.

In some implementations, the search system 300 determines the search results 220 based on the geographical search area 470 about the search location 460. Moreover, the search system 300 may rank the search results 220 based on the search area 470. The search results 220 include the access mechanisms 202 from the corresponding ones of the function records 330, respectively, identified by the search system 300. In some implementations, the search system 300 filters the access mechanisms 202 based on the search location 460. The search system 300 may also include filter out ones of the access mechanisms 202 corresponding to ones of the entities 402 located outside a geographical boundary (e.g. boundaries of the search area 470) around the search location 460. The size and/or shape of the search area 470 may be dictated by the local density 462 of the entities 402. Obtaining the one or more access mechanisms 202 may include generating a consideration set of the function records 330 based on the search query 212. As discussed above, each of the function records 330 may have an associated access mechanism, application state information, and an entity location. The search system 300 may score the consideration set of the function records 330 based on their associated entity locations with respect the search location 460 and a correspondence of the their application state information to the search criteria or the search query 212. An access mechanism, when executed by the user device 200, may cause the user device 200 to access an associated one of the native applications 204a, installed on the user device 200, launch the web browser application 204b installed on the user device 200 and access a web resource identified by the access mechanism, or access a digital distribution platform to download an associated application identified by the access mechanism 202.

### Advertising System

Referring to FIG. 5A, the search system 300 or the entity system 400 may obtain advertisement information for one or more of the entities 402 from the advertising system 500 for inclusion in the search results 220. The advertising system 500 includes an advertising module 510 in communication with an advertising data store 520. The advertising module 510 determines relevant advertising information from the search query 212 or data contained within the query wrapper 210. The advertising module 510 receives advertisement records from the advertising data store 520 containing advertisement records 530. The advertising system 500 passes relevant ones of the advertisement records 530 to the search system 300 (and/or the entity system 400) for possible inclusion in the search results 220. The inclusion of advertisement records 530 in the search results 220 may be based on the search area 470. Similarly, the search system 300 may rank the search results 220, in combination with the advertisements records 530, based on the search area 470. The advertisement records 530 may be generated by advertisers, by advertisement agencies, or by other third party providers.

FIGS. 5A and 5B illustrate examples of the advertising records 530 including an example one of the advertising records 530 (hereafter “ad record”). The ad record 530 may include a variety of different types of data related to an advertisement. For example, the ad record 530 may include an ad record name/ID 576, a sponsored function name/ID 578, ad content 580, and ad parameters 582. The ad parameters 582 include user parameters 594, platform parameters 596, budget parameters 598, and geolocation parameters 570. The advertising data store 520 may include other ones of the advertising records 530 each having a similar structure as that of the example one of the ad records 530. In other words, the advertising data store 520 may include one or more of the advertising records 530 each indicating one or more of an ad record name/ID, a sponsored function name/ID, ad content, and ad parameters.

As an example, the ad record 530 depicted in FIG. 5B includes the ad record name 576 “Advertisement for OpenTable—The French Laundry” having an ID “#1.” The ad record 530 also includes the sponsored function name 578, “OpenTable—The French Laundry” having an ID “#1.” In this example, the native application associated with the ad record 530 is OPENTABLE®. The sponsored function name 578 associated with the ad record 530 is an entry in OPENTABLE® for the restaurant The French Laundry.

The ad record 530 includes the ad content 580. The advertising system 500 (e.g., by the advertising module 510) generates or procures the ad content 580 used to generate an advertisement for the sponsored function name/ID 578. For example, the ad content 580 may include text and/or image data associated with one or more promotions or discounts related to the sponsored function, e.g., for one or more products or services provided by, or available via, the corresponding native application. The ad content 580 may include data that specifies conditions or terms of the promotions or discounts, such as one or more item names, item numbers, dollar amounts, times, and dates applicable thereto. In some examples, the ad content 580 includes text and/or image data that, when incorporated into the advertisement, causes display of one or more of the conditions or terms to the user (e.g., “10% OFF,” or “$10 OFF”). In other examples, the ad content 580 includes text and/or image data that, when incorporated into the advertisement, prompts the user 10 to download the corresponding native application (e.g., “Download Now!”).

The ad parameters 582 may specify when the advertising system 500 (e.g., the advertising module 510) generates the advertisement or when the advertisement is included in the search area 470. For example, as shown in the ad record 530, the ad parameters 582 may include user parameters 594, platform parameters 596, budget parameters 598, and/or the advertising geolocation 570. As a result, the advertising module 510 may generate the advertisement for one or more users or platforms (e.g., operating systems) of the user device 200 as defined by the user parameters 594 and the platform parameters 596. The advertising module 510 may also generate the advertisement for a defined number of users based on a budget associated with the advertisement (e.g., an advertisement campaign related to the advertisement) specified by the budget parameters 598. Additionally, the advertising module 510 may generate the advertisement only when the search location 460 is near the advertising geolocation 570.

### Searching Based on Entity Geo-Density

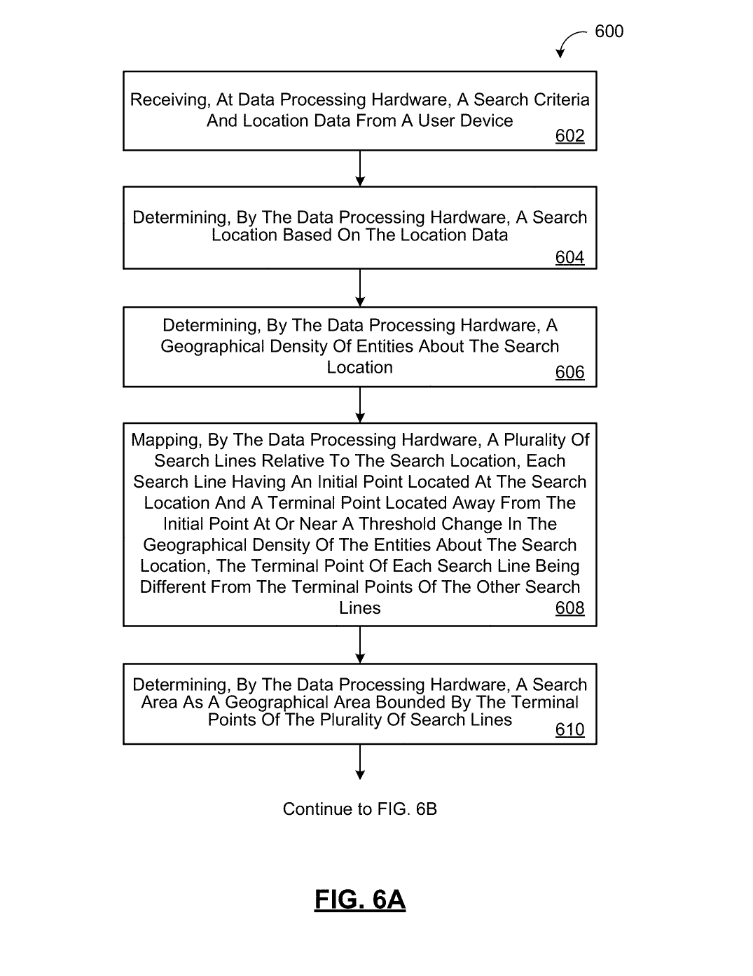

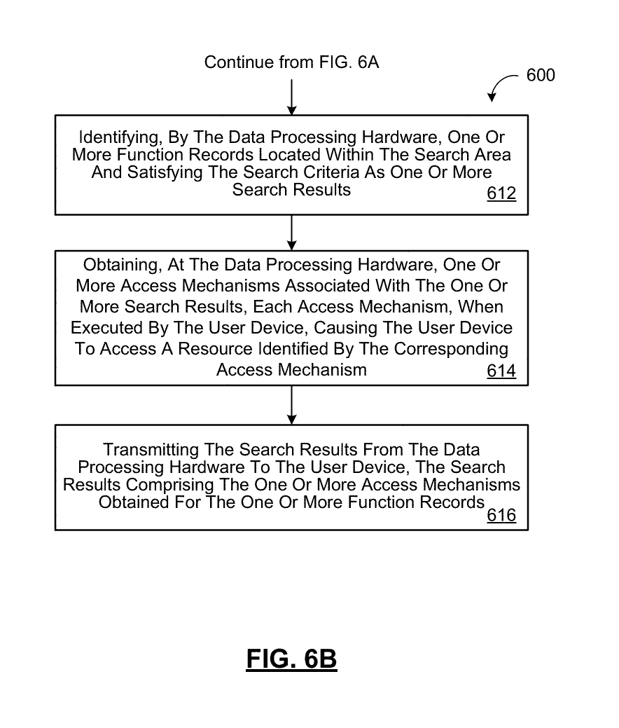

FIG. 6A provides an example method 600 for searching based on a local density of the entities 402, with additional reference to FIGS. 1A and 3A. While the method 600 is described with respect to the entity system 400, the method 600 may be executed by the search system 300 or other suitable systems.

At block 602, the method 600 includes receiving, at the data processing hardware 112, the query wrapper 210 or the search query 212, and the location data 218 from the user device 200. The user device 200 may send the query wrapper 210 including the search query 212 and the geolocation data 218 to the search system 300 executing on the data processing hardware 112. At block 604, the method 600 includes determining, by the data processing hardware 112, the search location 460 based on the location data or the geolocation data 218. The search location 460 may be based on the geolocation data 218. In some examples, the search location 460 is determined from the search query 212. At block 606, the method 600 includes determining, by the data processing hardware 112, the local density 462 of entities 402 about the search location 460. The entity system 400 uses the entity processing module 410 to access the entity data store 420 and the entity records 430. At block 608, the method 600 includes generating, by the data processing hardware 112, the search lines 464 relative to the search location 460. Each of the search lines 464 has an initial point located at the search location 460 and a terminal point located away from the search location 460 at or near a threshold change in the local density 462 of the entities 402 along that one of the search lines 464. The entity system 400 computes the search lines 464 extending away from the search location 460 and, as the search lines 464 are computed, the search lines 464 extend until the local density 462 at the terminal point decreases below a threshold value. The threshold value may be dependent on, including but not limited to, the search query 212, the search location 460, other information available to the entity system 400, etc. The terminal points of each of the search lines 464 are different from one another. The search lines 464 extend away from the search location 460. In some examples, the entity system 400 distributes the search lines 464 evenly (angularly) around the search location 460. The entity system 400 may also distribute the search lines 464 unevenly based on including, but not limited to, the entities 402 or geographical information, the search location 460, prior user searches, and/or mode of transportation, etc. For example, the search lines 464 may be weighted to extend along areas that are easily walkable, but not across freeways if the user 10 is known or likely to be walking. At block 610, the method 600 further includes determining, by the data processing hardware 112, the search area 470 as a geographical area bounded by the terminal points 468 of the plurality of search lines 464. At block 612, the method 600 includes identifying, by the data processing hardware 112, one or more of the function records 330 located within the search area 470 and satisfying the search criteria or search query 212 to yield the search results 220. The search system 300 determines the search results 220 related to the search query 212 and within the search area 470. At block 614, the method 600 includes obtaining, at the data processing hardware 112, one or more of the access mechanisms 202 associated with the one or more search results 220. The search system 300 accesses the search data store 320 and associated functional record 330 to determine the associated ones of the access mechanisms 202. Each of the access mechanisms 202, when executed by the user device 200, causes the user device 200 to access a resource identified by that one of the access mechanisms 202. At block 616, the method 600 includes transmitting the search results 220 from the data processing hardware 112 to the user device 200. The search system 300, entity system 400, or advertising system 500 transmits the search results 220 via the network 120 to the user device 200. The search results 220 include the one or more access mechanisms 202 obtained for the resulting one or more ones of the entities 402.

In some implementations, the method 600 includes determining whether at least one of the entities 402 located within the search area 470 satisfies the search criteria or search query 212. When none of the entities 402 located within the search area 470 satisfy the search criteria or search query 212, the method 600 may include increasing the threshold change in the local density 462 of the entities 402 about the search location 460, causing the search lines 464 to extend to the corresponding terminal points 468 located further away from the search location 460 to increase the search area 470. The method 600 may also include determining, whether a count of the resulting one or more ones of the entities 402 exceeds a threshold number. When the count exceeds the threshold number, the method 600 may include decreasing the threshold change in the local density of the entities 402, causing the search lines 464 to extend to the corresponding terminal points located closer to the search location 460 and to decrease the search area 470. The method 600 may also include obtaining advertisement information for the one or more target ones of the entities 402 from the advertising system 500.

In some implementations, the location data or the geolocation data 218 is indicative of the physical location of the user device 200 originating the search criteria or search query 212. The location data may include the geolocation data 218. The threshold change in the local density 462 of the entities 402 may be set based on a rate of change of the local density of the entities 402 in relation to the local density of the search location 460.

In some examples, the method 600 includes obtaining the transportation selection 234 indicating a type of transportation, wherein at least one of the terminal points is based on the transportation selection 234. For example, an increment may be chosen based on a transportation selection 234. Furthermore, as previously discussed, maximum and minimum lengths of search lines 464 may be adjusted for different transportation selections.

In some implementations, the method 600 includes filtering the access mechanisms 202 based on the search area 470. The method 600 may also include filtering out ones of the access mechanisms 202 corresponding to entity location data located outside a geographical boundary (e.g. the search area 470) around the search location 460. The size and/or shape of the search area 470 may be based on the local density 462 of the entities 402. Obtaining the one or more access mechanisms 202 may include generating a consideration set of function records 330 based on the search criteria or the search query 212. Each of the function records 330 may have an associated access mechanism, application state information, and an entity location. The method 600 may further include scoring the consideration set of the function records 330 based on the associated entity location data with respect the search location 460 and a correspondence of the application state information to the search criteria or the search query 212. Each of the access mechanisms 202, when executed by the user device 200, may cause the user device 200 to access an associated one of the native applications 204a, installed on the user device 200, launch the web browser application 204b installed on the user device 200 and access a web resource identified by that one of the access mechanisms 202, or access a digital distribution platform to download an application identified by the that one of the access mechanisms 202.

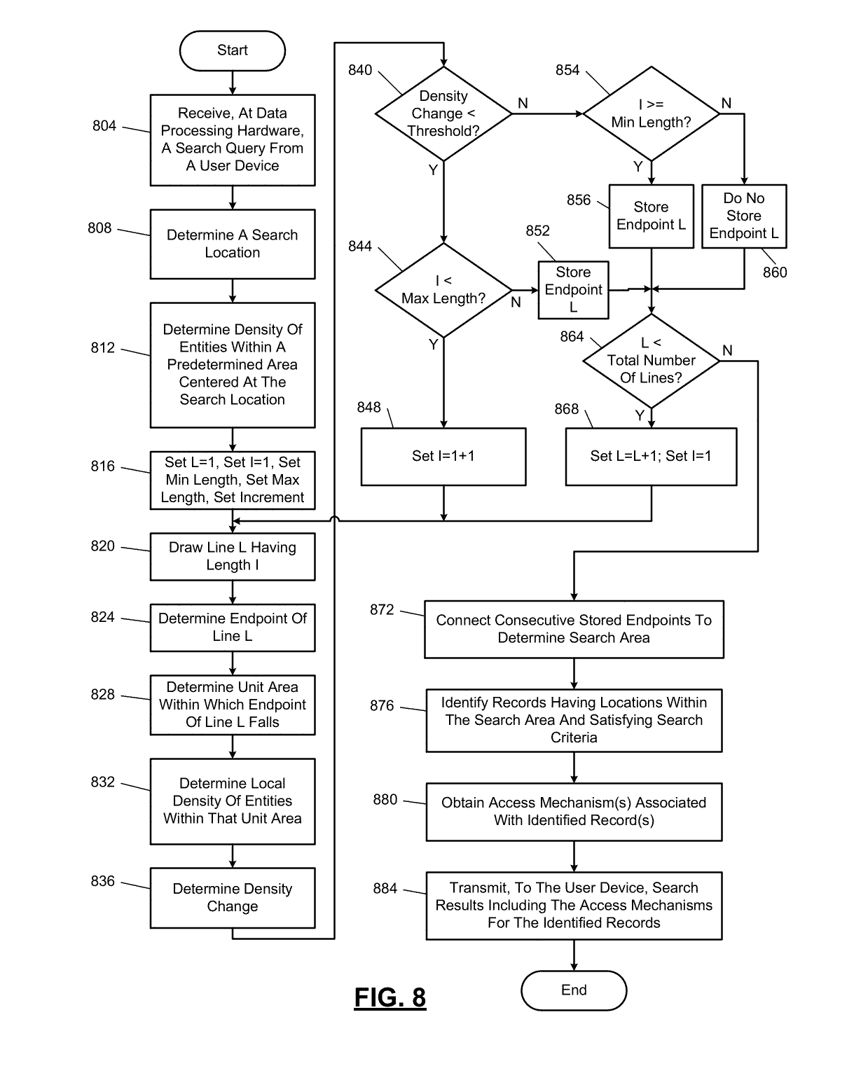

FIG. 8 is a flowchart depicting an example method for searching based on local densities of entities. While FIG. 8 will be described with in conjunction with the entity system 400, the method may be executed partially or completely by the search system 300 and/or one or more other suitable systems.

At 804, the data processing hardware 112 receives, from the user device 200, the query wrapper 210. The user device 200 may transmit the query wrapper 210 to the search system 300 executing on the data processing hardware 112.

At 808, the data processing hardware 112 determines the search location 460 for the query wrapper 210. For example, the data processing hardware 112 may set the search location 460 to the geolocation included in the geolocation data 218 or determine the search location 460. The data processing hardware 112 may determine the search location 460, for example, using the IP address 228 of the user device 200 or from the search query 212.

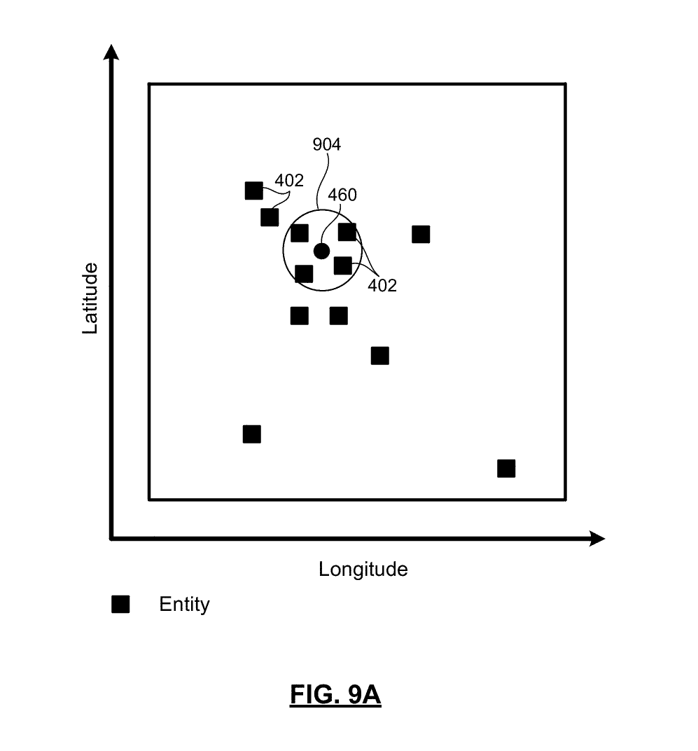

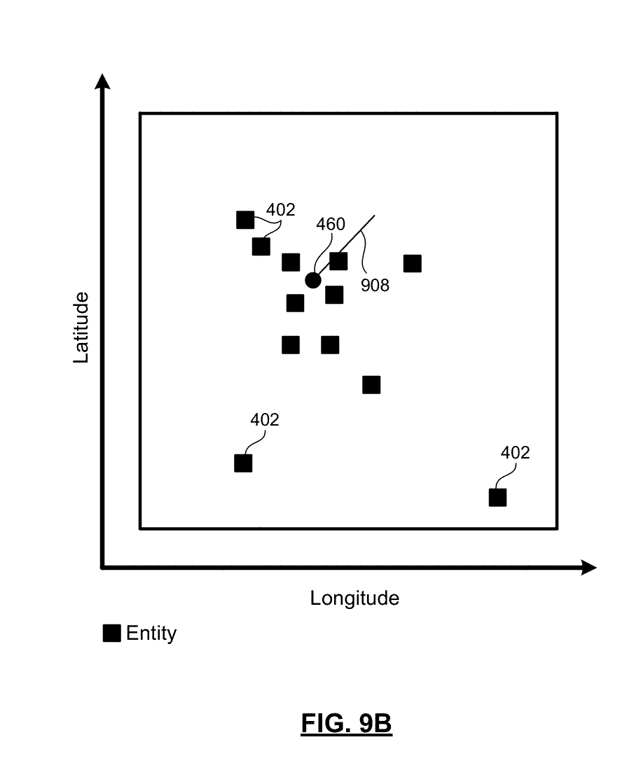

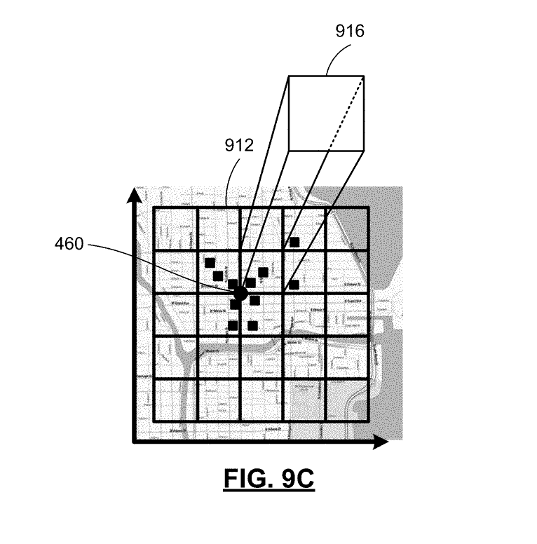

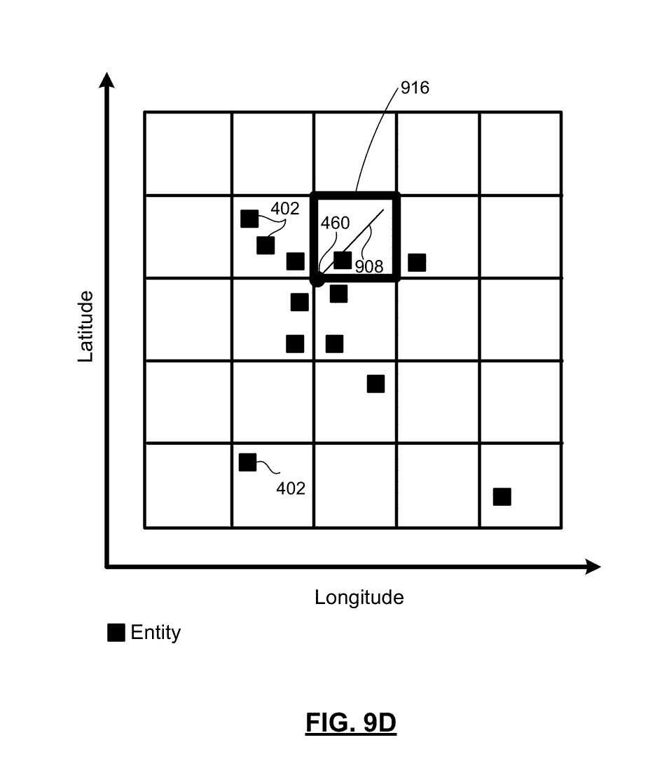

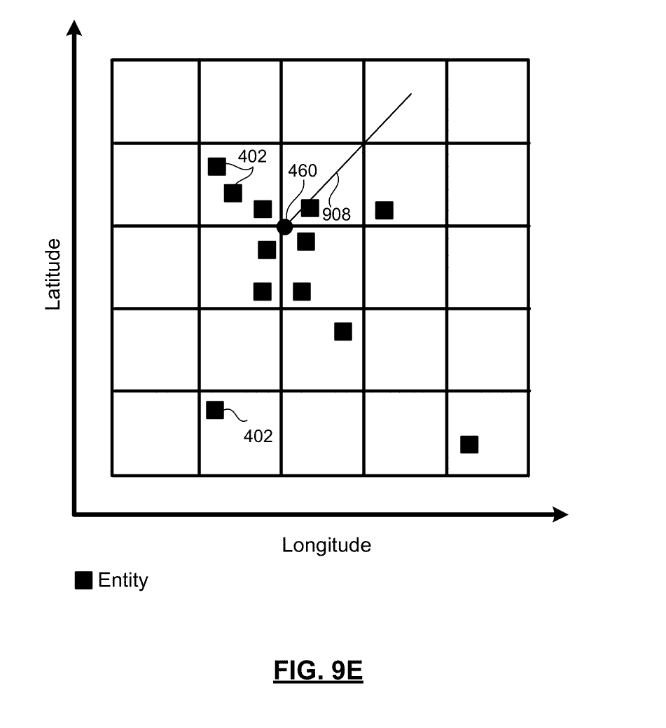

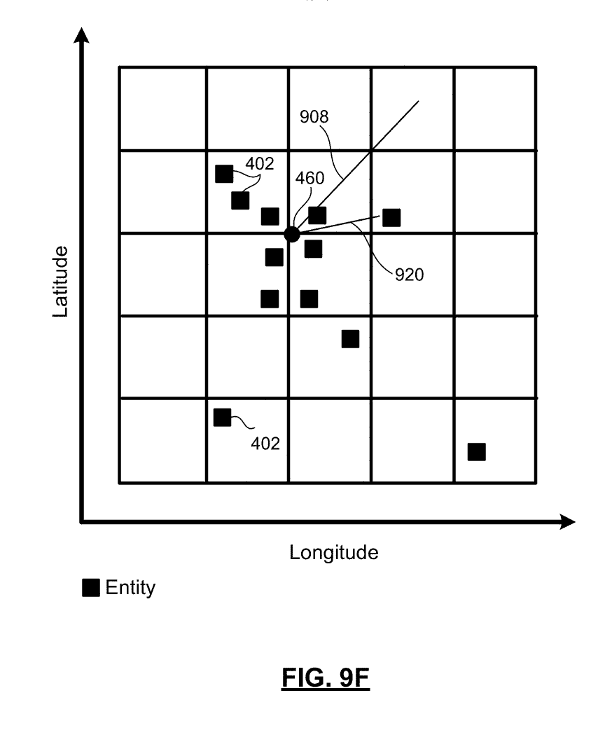

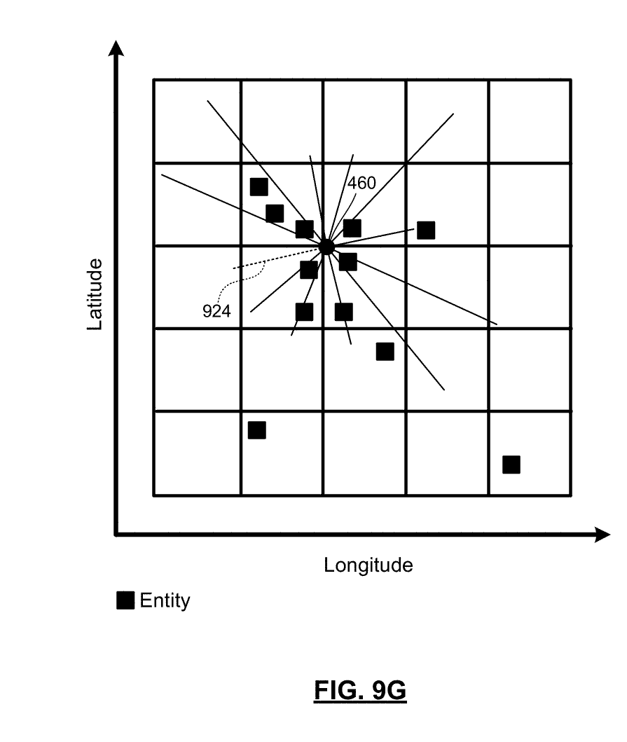

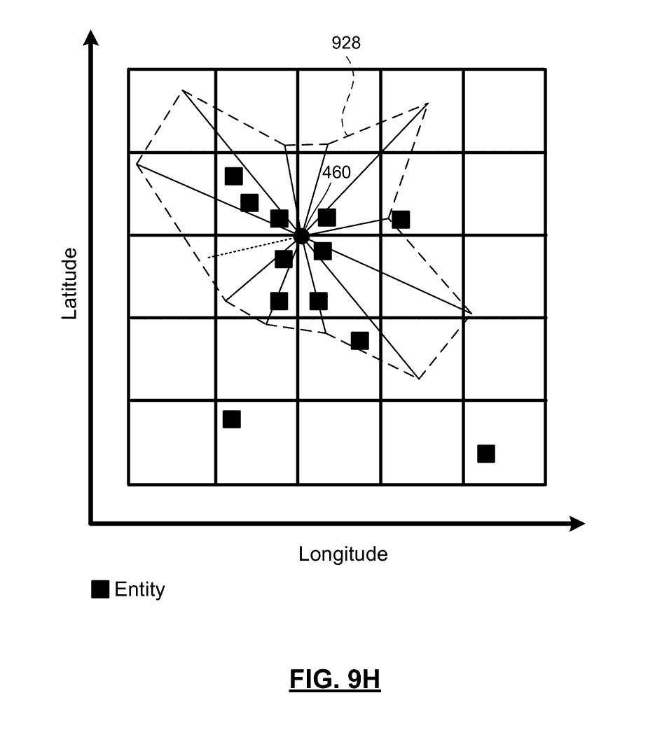

At 812, the data processing hardware 112 determines the local density 462 of ones of the entities 402 having location data that is within a predetermined area around (e.g., centered at) the search location 460. At 812, the determination may be non-specific as to whether the entities 404 match the search query 212 or not. As such, entities identified at 812 include location data that is within the predetermined area and may include entities that do not satisfy the search query 212 and entities that satisfy the search query 212. For example only, the predetermined area may be a circle centered at the search location 460 having a predetermined radius from the search location 460. FIG. 9A includes an example illustration of the predetermined area being a circle 904 centered at the search location 460. As another example, the predetermined area may be a rectangle centered at the search location 460 having one or more predetermined dimensions.

The data processing hardware 112 determine the local density for the search location 460 by counting the number of the entities 402 having location data that is within the predetermined area. In the example of FIG. 9A, four of the entities 402 have location data (in their respective ones of the entry records 430) that is within the predetermined area 904. The data processing hardware 112 may set the local density for the search location 460, for example, (i) to the number of the entities 402 having location data that is within the predetermined area or (ii) to the number of the entities 402 having location data that is within the predetermined area divided by the predetermined area.

At 816, the data processing hardware 112 may seta counter value L=1, set a counter value I=1, set the minimum length for the search lines 464, set the maximum length for the search lines 464, and set the increment length for each incremental lengthening of the search lines 464. The data processing hardware 112 uses the counter value L to draw the search lines 464 one search line at a time. The data processing hardware 112 uses the counter value I to set the length of and incrementally lengthen the search lines 464 and, more specifically, the one of the search lines 464 that is being drawn at that time. For example, the data processing hardware 112 draws the length of one of the search lines 464 that is being drawn according to the counter value I, as discussed further below.

In some examples, the minimum and maximum length may be integers (for comparison with the counter value I) that are greater than 1. The minimum length is less than the maximum length. In other examples, the minimum and maximum lengths may be distances for comparison with a length of a search line.

In some examples, the data processing hardware 112 may set the minimum length, the maximum length, and/or the increment length to predetermined fixed values. In some examples, the minimum length, the maximum length, and the increment length may be variable, and the data processing hardware 112 may set the minimum length, the maximum length, and the increment length based on the transportation selection 234. For example, the data processing hardware 112 may set the minimum length, the maximum length, and the increment length to first predetermined values when the transportation selection 234 is walking. The data processing hardware 112 may set the minimum length, the maximum length, and the increment length to second predetermined values when the transportation selection 234 is biking. One, more than one, or all of the second predetermined values may be greater than the first predetermined values, respectively. The data processing hardware 112 may set the minimum length, the maximum length, and the increment length to third predetermined values when the transportation selection 234 is driving. One, more than one, or all of the third predetermined values may be greater than the second predetermined values, respectively.

To determine the search area 470, the data processing hardware 112 draws a predetermined total number of the search lines 464 radially outwardly from the search location 460. The predetermined total number of search lines is an integer greater than or equal to 4. For example, the predetermined total number of the search lines 464 may be 6, 8, 10, 12, or another suitable number that is greater than or equal to 4. The data processing hardware 112 draws the search lines 464 at predetermined angles around the search location 460. The predetermined angles may be measured relative to a predetermined reference angle, such as North or a heading direction of the user device 200. In some examples, the predetermined angles may be equally spaced such that the (angular) spacing between adjacent ones of the search lines 464 is equal to 360° divided by predetermined total number of the search lines 464. In other examples, the predetermined angles may be non-equally spaced. The predetermined angles for drawing the search lines 464, respectively, may be stored in memory.

At 820, the data processing hardware 112 draws an L-th one of the search lines 464 (L being the counter value L) radially outwardly from the search location 460 at the predetermined angle for the L-th one of the search lines 464. The data processing hardware 112 draws the L-th one of the search lines 464 having a length corresponding to the counter value I. the data processing hardware 112 may set the length of the L-th one of the search lines 464, for example, by multiplying the counter value I by a predetermined unit distance (the predetermined increment length) for the search lines 464. In some examples, the predetermined unit distance (the predetermined increment length) may be greater than the distance between the search location 460 and the boundary of the predetermined area 904 such that the search lines 464 will extend outside of the predetermined area 904 when the counter value I is set to 1. In other examples, the predetermined unit distance (the predetermined increment length) may be less than the distance between the search location 460 and the boundary of the predetermined area 904 such that the search lines 464 will not extend outside of the predetermined area 904 when the counter value I is set to 1. FIG. 9B includes an example illustration of a first one of the search lines 464 (L=1) for when the counter value I=1.

At 824, the data processing hardware 112 may determine and endpoint location (e.g., coordinates) of the L-th one of the search lines 464. The data processing hardware 112 may determine the endpoint location of the L-th one of the search lines 464, for example, based on the search location 460 (e.g., coordinates), the predetermined angle for the L-th one of the search lines 464 relative to the predetermined reference angle, and the present length of the L-th one of the search lines 464 (or the counter value I). While actually drawing the search lines 464 is described herein for illustrative purposes, the data processing hardware 112 may not draw the lines and instead incrementally determine the endpoint locations for each of the search lines 464.

The geographical area surrounding the search location 460 is divided into a grid of predetermined unit areas for the purpose of determining the search area 470. More specifically, boundaries of the predetermined unit areas will be used to determine local densities of entities for endpoints within the predetermined unit areas, respectively. The predetermined unit areas may be, for example, one or more city blocks, one or more acres, a fraction or a whole square unit of distance (e.g., square feet, square meters, square kilometers, square mile, etc.), or another suitable predetermined unit area. FIG. 9C includes an example grid 912 of predetermined unit areas, such as predetermined unit area 916.

At 828, the data processing hardware 112 determines which one of the predetermined unit areas the endpoint location of the L-th one of the search lines 464 is within. The data processing hardware 112 may determine which one of the predetermined unit areas the endpoint location of the L-th one of the search lines 464 is within by comparing the endpoint location with locations (e.g., of coordinates) of boundaries of the predetermined unit areas. FIG. 9D includes an example illustration where the endpoint location of the search line 908 falls within the predetermined unit area 916.

At 832, the data processing hardware 112 determines a local density of entities within the one of the predetermined unit areas that the endpoint of the L-th one of the search lines 464 is within. For example, the data processing hardware 112 may determine the local density within the one of the predetermined unit areas by counting the number of the entities 402 that have location data that is within the one of the predetermined unit areas. The data processing hardware 112 may set the local density for the one of the predetermined unit areas, for example, (i) to the number of the entities 402 that satisfy the search query 212 and have location data that is within the one of the predetermined unit areas or (ii) to the number of the entities 402 that satisfy the search query 212 and have location data that is within the one of the predetermined unit area divided by the areas of the predetermined unit areas. At 832, the determination may be non-specific as to whether the entities 404 match the search query 212 or not. As such, entities identified at 832 include location data that is within the predetermined area and may include entities that do not satisfy the search query 212 and entities that satisfy the search query 212. The data processing hardware 112 may also set the threshold change as described above at 832.

At 836, the data processing hardware 112 determines a density change for the one of the predetermined unit areas. The data processing hardware 112 determines the density change for the one of the predetermined unit areas based on a difference between the local density of entities of the one of the predetermined unit areas and a previous local density of entities. For example, the data processing hardware 112 may set the density change for the one of the predetermined unit areas based on or equal to the previous local density of the entities minus the local density of the one of the predetermined unit areas. In some examples, the previous local density may be the local density of entities within the predetermined area 904 around the search location 460. In other examples, the previous local density may be a previous (e.g., last) local density of entities determined for a different one of the predetermined unit areas for a previous endpoint of the L-th one of the search lines before the counter value I was last incremented (e.g., from I=I−1, I=I−2, etc.).

At 840, the data processing hardware 112 may determine whether the density change is less than the threshold change. When the density change is less than the threshold change (i.e., 840 is true), control may continue with 844. When the density change is greater than or equal to the threshold change (i.e., 840 is false), control may transfer to 854, which is discussed further below.

At 844, the data processing hardware 112 may determine whether the counter value I (corresponding to the length of the L-th one of the search lines 464) is less than the maximum length for the search lines 464. When the counter value I is less than the maximum length (i.e., 844 is true), the data processing hardware 112 may increment the counter value I (e.g., set I=I+1) to increment the length of the L-th one of the search lines at 848. Control may then return to 820 determine the local density within the one of the predetermined areas of the new endpoint of the L-th one of the search lines, etc. FIG. 9E includes an example illustration of the search line 908 after it has been incrementally lengthened. When the counter value I is greater than or equal to the maximum length (i.e., 844 is false), the data processing hardware 112 may store the present endpoint of the L-th one of the search lines 464 at 852, and control continues with 864, which is discussed below. This limits the length of the L-th one of the search lines to the maximum length.

Referring back to 854 (arrived at when the density change is greater than or equal to the threshold change), the data processing hardware 112 may determine whether the counter value I (corresponding to the length of the L-th one of the search lines 464) is greater than or equal to the minimum length for the search lines 464. When the counter value I is greater than or equal to the minimum length, the data processing hardware 112 may store an endpoint of the L-th one of the search lines 464 at 856, and control may continue with 864. In some example, (e.g., when the counter value I is equal to the minimum length) the data processing hardware 112 may store the present endpoint location of the L-th one of the search lines 464 at 856. In other examples, (e.g., when the counter value I is greater than the minimum length), the data processing hardware 112 may store the last endpoint location (for when I=I−1) of the L-th one of the search lines 464 at 856. When the counter value I is less than the minimum length, the data processing hardware 112 may not store an endpoint location for the L-th one of the search lines 464 at 860, and control may continue with 864. By not storing the endpoint location of the L-th one of the search lines 464, the L-th one of the search lines 464 will not be used to define the search area 470. Alternatively, the data processing hardware 112 may store the search location 460 as the L-th one of the search lines 464 at 860.

At 864, the data processing hardware 112 may determine whether the counter value L (corresponding to the current one of the search lines being assessed) is less than the predetermined total number of search lines. When L is less than the predetermined total number of search lines to be assessed (i.e., 868 is true), the data processing hardware 112 increments the counter value L (e.g., set L=L+1) and sets the counter value I back to 1 at 868, and control returns to 820 to proceed with the next one of the L search lines. FIG. 9F includes an example of a second search line 920 with the counter value I=1.

When L is greater than or equal to the predetermined total number of search lines to be assessed (i.e., 868 is false), the data processing hardware 112 transfers to 872. In this case, all of the search lines have been assessed. FIG. 9G includes an example drawing after all of a predetermined total number of search lines have been drawn. In the example of FIG. 9G, the length of dashed search line 924, when the density change is greater than the threshold change, is less than the minimum length. As such, the endpoint location of the dashed search line 924 will not be used to determine the search area 470.

At 872, the data processing hardware 112 connects the stored endpoint locations of adjacent search lines to define the search area 470 for the query wrapper 210. FIG. 9H includes an example search area 928 defined by connecting the stored endpoint locations of adjacent search lines. As shown, the endpoint of dashed search line 924 is not used to define the search area 928 since the length of the dashed search line 924 is not greater than or equal to the minimum length.

At 876, the data processing hardware 112 identifies one or more of the function records 330 located within the search area 470 (defined at 872) and satisfying the search criteria or search query 212 to yield the search results 220. The search system 300 determines the search results 220 related to the search query 212 and within the search area 470.

The data processing hardware 112 obtains one or more of the access mechanisms 202 associated with the one or more search results 220 at 880. The search system 300 accesses the search data store 320 and associated function records 330 to determine the associated ones of the access mechanisms 202. Each of the access mechanisms 202, when executed by the user device 200, causes the user device 200 to access a resource identified by that one of the access mechanisms 202.

At 884, the data processing hardware 112 transmits the search results 220 to the user device 200. The search system 300, the entity system 400, or the advertising system 500 transmits the search results 220 via the network 120 to the user device 200. The search results 220 include the one or more access mechanisms 202 obtained for the resulting one or more ones of the entities 402.

### Computing Devices

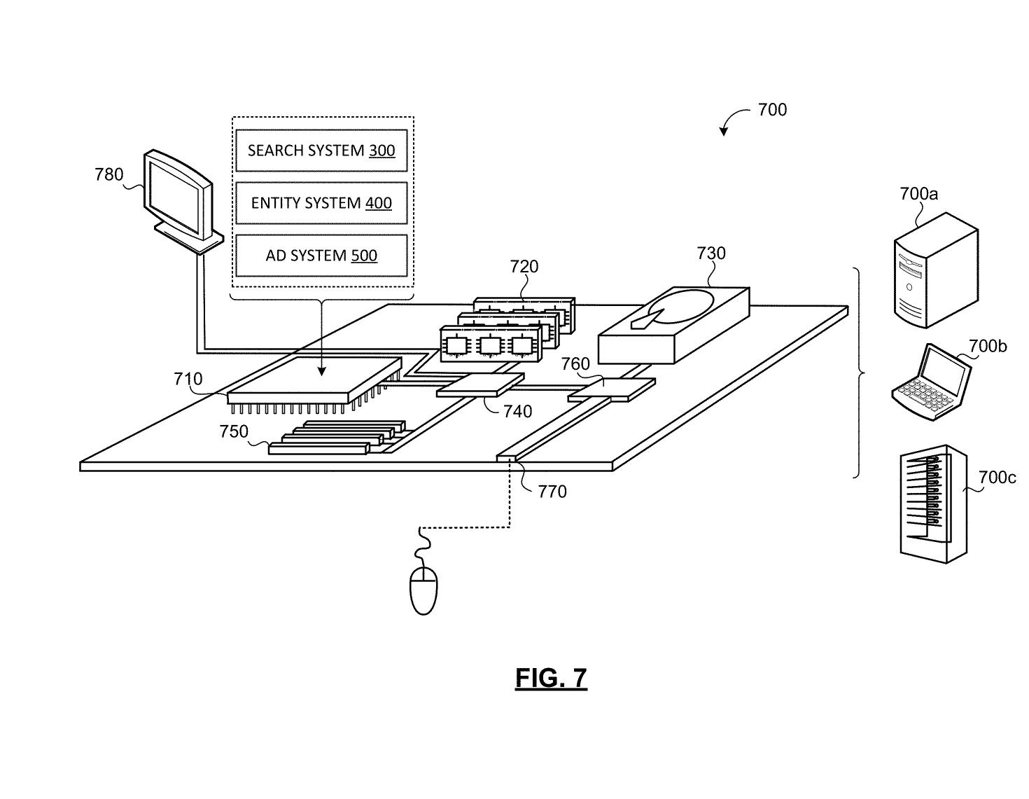

FIG. 7 is schematic view of an example computing device 700 that may be used to implement the systems and methods described in this document, such as the remote system 110. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the disclosures described and/or claimed in this document.

The computing device 700 includes a processor 710, memory 720, a storage device 730, a high-speed interface/controller 740 connecting to the memory 720 and high-speed expansion ports 750, and a low speed interface/controller 760 connecting to low speed bus 770 and storage device 730. Each of the components 710, 720, 730, 740, 750, and 760, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 720 stores information non-transitorily within the computing device 700. The memory 720 may be a computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM).

The storage device 730 is capable of providing mass storage for the computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 720, the storage device 730, or memory on processor 710.

The high speed controller 740 manages bandwidth-intensive operations for the computing device 700, while the low speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and low-speed expansion port 770. The low-speed expansion port 770, which may include various communication ports (e.g., USB, Bluetooth, Ethernet, wireless Ethernet), may be coupled to one or more input/output devices, such as a keyboard, a pointing device, a scanner, or a networking device, such as a switch or router, e.g., through a network adapter.

The computing device 700 may be implemented in a number of different forms, as shown in the figure. For example, it may be implemented as a standard server 700a or multiple times in a group of such servers 700a, as a laptop computer 700b, or as part of a rack server system 700c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. §112(f) unless an element is expressly recited using the phrase “means for” or, in the case of a method claim, using the phrases “operation for” or “step for.”

What is claimed is:

1. A method comprising:
receiving, by one or more processors, a search query from a user device;
determining, by the one or more processors, a geographic search location for the search query;
determining, by the one or more processors, geographic endpoint locations for search lines, respectively, the search lines radiating outwardly from the geographic search location in predetermined directions, respectively,
wherein determining the geographic endpoint locations includes, for each search line of the search lines, by the one or more processors:
(i) initializing a distance of the search line to a first value;
(ii) determining a possible geographic endpoint location for the search line, the possible geographic endpoint location being the distance away from the geographic search location in the predetermined direction corresponding to the search line;
(iii) determining, based on the possible geographic endpoint location and geographic boundaries of a plurality of predetermined unit areas, one of the plurality of predetermined unit areas within which the possible endpoint location lies;
(iv) determining, from entity records stored in memory, a number of entities having geographic locations that are within the one of the plurality of predetermined unit areas;
(v) determining a decrease in the number of entities relative to a previous number of entities having geographic locations within another predetermined area;
(vi) determining whether the decrease is greater than a threshold value; and
(vii) in response to the decrease being greater than the threshold value, storing as the endpoint location for the search line one of: (a) the possible geographic endpoint location and (b) a previous instance of the possible geographic endpoint location of the one of the search lines; and in response to the decrease not being greater than the threshold value, incrementing the distance by a predetermined increment value and repeating (ii)-(vii);
determining, by the one or more processors, geographic boundaries of a search area for the search query by connecting stored ones of the geographic endpoint locations for the search lines, respectively;
determining, by the one or more processors, from the entity records stored in the memory, search results entities that: (i) have geographic locations that are within the geographic boundaries of the search area; and (ii) satisfy the search query;
obtaining from memory, by the one or more processors, access mechanisms associated with the search results entities, respectively,
wherein each access mechanism of the access mechanisms, when executed by the user device, causes the user device to transition an application to a specific state associated with the access mechanism; and
transmitting to the user device, by the one or more processors, the access mechanisms and link data for the search results entities.

2. The method of claim 1 further comprising:
determining, by the one or more processors from the entity records stored in memory, a second set of entities, wherein each entity of the second set of entities both (i) is associated with a location within a predetermined area around the geographic search location and (ii) satisfies the search query; and
in response to a count of entities in the second set of entities being zero, one of:
(i) setting the threshold value to a first predetermined value greater than zero; and
(ii) increasing the threshold value.

3. The method of claim 2 further comprising, in response to the count of entities in the second set of entities being greater than zero, one of:
(i) setting the threshold value to a second predetermined value that is less than the first predetermined value; and
(ii) decreasing the threshold value.

4. The method of claim 1 further comprising receiving from the user device, by the one or more processors, a geographic location of the user device,
wherein determining the geographic search location for the search query includes setting the geographic search location to the geographic location of the user device.

5. The method of claim 1 further comprising receiving from the user device, by the one or more processors, an Internet Protocol (IP) address of the user device,
wherein determining the geographic search location for the search query includes determining the geographic search location for the search query based on the IP address of the user device.

6. The method of claim 1 wherein determining the geographic search location for the search query includes, by the one or more processors, determining the geographic search location for the search query based on one or more words included in the search query.

7. The method of claim 1, further comprising:
receiving from the user device, by the one or more processors, a transportation selection indicative of a type of transportation of a user of the user device; and
by the one or more processors, at least one of:
setting the threshold value based on the transportation selection; and
setting the predetermined increment value based on the transportation selection.

8. The method of claim 1 further comprising:
determining, by the one or more processors from the entity records stored in memory, a second set of entities, wherein each entity of the second set of entities is associated with a location within a predetermined area centered at the geographic search location,
wherein the previous number of entities having geographic locations within another predetermined area is a count of entities in the second set of entities.

9. The method of claim 1 wherein the previous number of entities having geographic locations within another predetermined area is the number of entities within another predetermined unit area from a previous iteration of (iv) for the search line.

10. The method of claim 1, wherein each access mechanism of the access mechanisms, when executed by the user device, causes the user device to at least one of:
transition a software application installed on the user device to the specific state;
launch a web browser application installed on the user device and access a specific webpage; and
access a digital distribution platform to download an application.

11. A non-transitory computer-readable medium storing instructions for execution by one or more processors of a computing device, the instructions comprising instructions for:
determining a geographic search location for a search query received from a user device;
determining geographic endpoint locations for search lines, respectively, the search lines radiating outwardly from the geographic search location in predetermined directions, respectively,
wherein the instructions for determining the geographic endpoint locations include, for each search line of the search lines, instructions for:
(i) initializing a distance of the search line to a first value;
(ii) determining a possible geographic endpoint location for the search line, the possible geographic endpoint location being the distance away from the geographic search location in the predetermined direction corresponding to the search line;
(iii) determining, based on the possible geographic endpoint location and geographic boundaries of a plurality of predetermined unit areas, one of the plurality of predetermined unit areas within which the possible endpoint location lies;
(iv) determining, from entity records stored in memory, a number of entities having geographic locations that are within the one of the plurality of predetermined unit areas;
(v) determining a decrease in the number of entities relative to a previous number of entities having geographic locations within another predetermined area;
(vi) determining whether the decrease is greater than a threshold value; and
(vii) in response to the decrease being greater than the threshold value, storing as the endpoint location for the search line one of: (a) the possible geographic endpoint location and (b) a previous instance of the possible geographic endpoint location of the one of the search lines; and in response to the decrease not being greater than the threshold value, incrementing the distance by a predetermined increment value and repeating (ii)-(vii);
determining geographic boundaries of a search area for the search query by connecting stored ones of the geographic endpoint locations for the search lines, respectively;
determining, from the entity records stored in the memory, search results entities that: (i) have geographic locations that are within the geographic boundaries of the search area; and (ii) satisfy the search query;
obtaining, from memory, access mechanisms associated with the search results entities, respectively,
wherein each access mechanism of the access mechanisms, when executed by the user device, causes the user device to transition an application to a specific state associated with the access mechanism; and
transmitting, to the user device, the access mechanisms and link data for the search results entities.

12. The non-transitory computer-readable medium of claim 11 further comprising instructions executed by the one or more processors for:
determining, from the entity records stored in memory, a second set of entities, wherein each entity of the second set of entities both (i) is associated with a location within a predetermined area around the geographic search location and (ii) satisfies the search query; and
in response to a count of entities in the second set of entities being zero, one of:
(i) setting the threshold value to a first predetermined value greater than zero; and
(ii) increasing the threshold value.

13. The non-transitory computer-readable medium of claim 12 further comprising instructions executed by the one or more processors for, in response to the second count of entities in the second set of entities being greater than zero, one of:
(i) setting the threshold value to a second predetermined value that is less than the first predetermined value; and
(ii) decreasing the threshold value.

14. The non-transitory computer-readable medium of claim 11 wherein the instructions for determining the geographic search location for the search query include instructions for setting the geographic search location to a geographic location of the user device received from the user device.

15. The non-transitory computer-readable medium of claim 11 wherein the instructions for determining the geographic search location for the search query include instructions for determining the geographic search location for the search query based on an Internet Protocol (IP) address of the user device received from the user device.

16. The non-transitory computer-readable medium of claim 11 wherein the instructions for determining the geographic search location for the search query include instructions for determining the geographic search location for the search query based on one or more words included in the search query.

17. The non-transitory computer-readable medium of claim 11 further comprising instructions executed by the one or more processors for:
at least one of:
setting the threshold value based on a transportation selection received from the user device, the transportation selection being indicative of transportation of a user of the user device; and
setting the predetermined increment value based on the transportation selection.

18. The non-transitory computer-readable medium of claim 11 further comprising instructions executed by the one or more processors for:
determining, by the one or more processors from the entity records stored in memory, a second set of entities, wherein each entity of the second set of entities is associated with a location within a predetermined area centered at the geographic search location,
wherein the instructions for (v) determining the decrease in the number of entities relative to the previous number of entities having geographic locations within another predetermined area include instructions for (v) determining the decrease in the number of entities relative to a count of entities in the second set of entities.

19. The non-transitory computer-readable medium of claim 11 wherein the instructions for (v) determining the decrease in the number of entities relative to the previous number of entities having geographic locations within another predetermined area include instructions for (v) determining the decrease in the number of entities relative to the number of entities determined from a previous iteration of (iv) for the search line.

20. The non-transitory computer-readable medium of claim 11 wherein each access mechanism of the access mechanisms, when executed by the user device, causes the user device to at least one of:
transition a software application installed on the user device to the specific state;
launch a web browser application installed on the user device and access a specific webpage; and
access a digital distribution platform to download an application.

21. A system comprising:
one or more processors; and
memory comprising instructions that, when executed by the one or more processors, cause the one or more processors to:
determine a geographic search location for a search query received from a user device;
determine geographic endpoint locations for search lines, respectively, the search lines radiating outwardly from the geographic search location in predetermined directions, respectively,
the determination of the geographic endpoint locations including, for each search line of the search lines:
(i) initializing a distance of the search line to a first value;
(ii) determining a possible geographic endpoint location for the search line, the possible geographic endpoint location being the distance away from the geographic search location in the predetermined direction corresponding to the search line;
(iii) determining, based on the possible geographic endpoint location and geographic boundaries of a plurality of predetermined unit areas, one of the plurality of predetermined unit areas within which the possible endpoint location lies;
(iv) determining, from entity records stored in memory, a number of entities having geographic locations that are within the one of the plurality of predetermined unit areas;
(v) determining a decrease in the number of entities relative to a previous number of entities having geographic locations within another predetermined area;
(vi) determining whether the decrease is greater than a threshold value; and
(vii) in response to the decrease being greater than the threshold value, storing as the endpoint location for the search line one of: (a) the possible geographic endpoint location and (b) a previous instance of the possible geographic endpoint location of the one of the search lines; and in response to the decrease not being greater than the threshold value, incrementing the distance by a predetermined increment value and repeating (ii)-(vii);
determine geographic boundaries of a search area for the search query by connecting stored ones of the geographic endpoint locations for the search lines, respectively;
determine, from the entity records stored in the memory, search results entities that: (i) have geographic locations that are within the geographic boundaries of the search area; and (ii) satisfy the search query;
obtain from memory, access mechanisms associated with the search results entities, respectively,
wherein each access mechanism of the access mechanisms, when executed by the user device, causes the user device to transition an application to a specific state associated with the access mechanism; and
transmit to the user device, the access mechanisms and link data for the search results entities.
